(19) United States
(12) Patent Application Publication
(10) Pub. No.: US 2023/0003895 A1
(43) Pub. Date: Jan. 5, 2023

(54) METHOD AND APPARATUS FOR CONTROLLING DISTANCE MEASUREMENT APPARATUS

(71) Applicant: Panasonic Intellectual Property Management Co., Ltd., Osaka (JP)

(72) Inventors: YUMIKO KATO, Osaka (JP); YASUHISA INADA, Osaka (JP); KENJI NARUMI, Osaka (JP); KAZUYA HISADA, Nara (JP)

(21) Appl. No.: 17/931,146

(22) Filed: Sep. 12, 2022

Related U.S. Application Data
(63) Continuation of application No. PCT/JP2021/008435, filed on Mar. 4, 2021.

(30) Foreign Application Priority Data
Apr. 3, 2020 (JP) 2020-067522

(51) Int. Cl. G01S 17/894; G01S 17/931; G06T 7/521; G06T 7/579

(52) U.S. Cl. CPC G01S 17/894; G01S 17/931; G06T 7/521; G06T 7/579; G06T 2207/10028; G06T 2207/30252; G08G 1/16

(57) ABSTRACT

A method for controlling a distance measurement apparatus including a light emitting device capable of changing a direction of emission of a light beam and a light receiving device that detects a reflected light beam includes acquiring data representing a plurality of images acquired at different points in time by an image sensor that acquires an image of a scene, determining, on the basis of the data representing the plurality of images, a degree of priority of distance measurement of one or more physical objects included in the plurality of images, and executing distance measurement of the one or more physical objects by causing the light emitting device to emit the light beam in a direction corresponding to the degree of priority and in an order corresponding to the degree of priority and causing the light receiving device to detect the reflected light beam.

### BACKGROUND

### 1. Technical Field

The present disclosure relates to a method and apparatus for controlling a distance measurement apparatus.

### 2. Description of the Related Art

It is important for a self-propelled system such as a self-guided vehicle and a self-propelled robot to avoid a collision with another vehicle, a person, or other objects. For that purpose, a system that carries out sensing of an external environment with a camera or a distance measurement apparatus has been used.

As for distance measurement, there have been proposed a variety of devices each of which measures the distance to one or more objects present in a space. For example, Japanese Unexamined Patent Application Publication No. 2018-124271, Japanese Unexamined Patent Application Publication No. 2009-217680, and Japanese Unexamined Patent Application Publication No. 2018-049014 disclose systems each of which measures the distance to an object with a TOF (time-of-flight) technology.

Japanese Unexamined Patent Application Publication No. 2018-124271 discloses a system that measures the distance to an object by detecting reflected light from the object. While changing the direction of a light beam in each of a plurality of frame periods, this system causes one or more light receiving elements of an image sensor to sequentially detect the reflected light. Such an operation successfully shortens the time required to acquire distance information on the entire target scene.

Japanese Unexamined Patent Application Publication No. 2009-217680 discloses a method for detecting a traverse object that moves in a direction different from the direction of movement of an own vehicle. It is disclosed, for example, that a reduction in signal-to-noise ratio is achieved by increasing the intensity or number of emissions of an optical pulse from a light source.

In order to obtain detailed distance information on a distant physical object, Japanese Unexamined Patent Application Publication No. 2018-049014 discloses providing, separately from a first distance measurement apparatus, a second distance measurement apparatus that emits a light beam to a distant physical object.

### SUMMARY

One non-limiting and exemplary embodiment provides a technology for more efficiently acquiring distance information on one or more physical objects that are present in a scene.

In one general aspect, the techniques disclosed here feature a method for controlling a distance measurement apparatus including a light emitting device capable of changing a direction of emission of a light beam and a light receiving device that detects a reflected light beam produced by the emission of the light beam. The method includes acquiring data representing a plurality of images acquired at different points in time by an image sensor that acquires an image of a scene to be subjected to distance measurement, determining, on the basis of the data representing the plurality of images, a degree of priority of distance measurement of one or more physical objects included in the plurality of images, and executing distance measurement of the one or more physical objects by causing the light emitting device to emit the light beam in a direction corresponding to the degree of priority and in an order corresponding to the degree of priority and causing the light receiving device to detect the reflected light beam.

It should be noted that general or specific aspects of the present disclosure may be implemented as a system, an apparatus, a method, an integrated circuit, a computer program, a storage medium such as a computer-readable storage disk, or any selective combination thereof. The computer-readable storage medium may include a nonvolatile storage medium such as a CD-ROM (compact disc-read-only memory). The apparatus may be constituted by one or more apparatuses. In a case where the apparatus is constituted by two or more apparatuses, the two or more apparatuses may be placed within one piece of equipment, or may be placed separately in each of two or more separate pieces of equipment. The term “apparatus” as used herein or in the claims may not only mean one apparatus but also mean a system composed of a plurality of apparatuses.

An aspect of the present disclosure makes it possible to more efficiently acquire distance information on one or more physical objects that are present in a scene.

Additional benefits and advantages of an aspect of the present disclosure will become apparent from the specification and drawings. The benefits and/or advantages may be individually obtained by the various aspects and features of the specification and drawings, which need not all be provided in order to obtain one or more of such benefits and/or advantages.

### BRIEF DESCRIPTION OF THE DRAWINGS

FIG. 1 is a diagram schematically showing a distance measurement system according to an exemplary embodiment of the present disclosure;

FIG. 2 is a diagram showing an example of a light emitting device;

FIG. 3 is a perspective view schematically showing another example of the light emitting device;

FIG. 4 is a diagram schematically showing an example of a structure of an optical waveguide element;

FIG. 5 is a diagram schematically showing an example of a phase shifter;

FIG. 6 is a diagram for explaining an example of an indirect TOF distance measurement method;

FIG. 7 is a diagram for explaining another example of an indirect TOF distance measurement method;

FIG. 8A is a diagram showing an example of data that is stored in a first storage device;

FIG. 8B is a diagram showing an example of data that is stored in the first storage device;

FIG. 8C is a diagram showing an example of data that is stored in the first storage device;

FIG. 8D is a diagram showing an example of data that is stored in the first storage device;

FIG. 9A is a diagram showing an example of data that is stored in a second storage device;

FIG. 9B is a diagram showing an example of data that is stored in the second storage device;

FIG. 9C is a diagram showing an example of data that is stored in the second storage device;

FIG. 9D is a diagram showing an example of data that is stored in the second storage device;

FIG. 10 is a diagram showing an example of data that is stored in a third storage device;

FIG. 11 is a flow chart presenting an overview of an operation of the distance measurement system;

FIG. 12A is a diagram showing an example of a distance measurement method for each cluster;

FIG. 12B is a diagram showing an example of a distance measurement method for each cluster;

FIG. 12C is a diagram showing an example of a distance measurement method for each cluster;

FIG. 13 is a flow chart showing details of an action of step S1400 in FIG. 11;

FIG. 14A is a diagram showing an example of an immediately preceding frame f0 of image;

FIG. 14B is a diagram showing an example of a current frame f1 of image;

FIG. 14C is a diagram displaying motion vectors with the frames f0 and f1 of image superimposed on top of each other;

FIG. 14D is a diagram showing examples of motion vectors based on own-vehicle movement;

FIG. 14E is a diagram showing examples of relative velocity vectors;

FIG. 15 is a flow chart showing details of a process for calculating a motion vector based on own-vehicle movement in step S1407;

FIG. 16A is a diagram showing examples of apparent motion vectors in a case where the distance measurement system is placed at the front of a movable body and the movable body is traveling forward;

FIG. 16B is a diagram showing examples of apparent motion vectors in a case where the distance measurement system is placed at the right front of the movable body and the movable body is traveling forward;

FIG. 16C is a diagram showing examples of apparent motion vectors in a case where the distance measurement system is placed on the right side of the movable body and the movable body is traveling forward;

FIG. 16D is a diagram showing examples of apparent motion vectors in a case where the distance measurement system is placed at the center rear of the movable body and the movable body is traveling forward;

FIG. 17 is a flow chart showing details of a process of risk calculation in step S1500;

FIG. 18 is a diagram for explaining an example of a process of step S1503;

FIG. 19 is a flow chart showing a detailed example of a method for calculating a degree of risk according to rate of acceleration in step S1504;

FIG. 20A is a first diagram for explaining a process for calculating an acceleration vector in a case where an own vehicle is traveling straight forward at a constant speed;

FIG. 20B is a second diagram for explaining the process for calculating an acceleration vector in a case where the own vehicle is traveling straight at a constant speed;

FIG. 20C is a third diagram for explaining the process for calculating an acceleration vector in a case where the own vehicle is traveling straight forward at a constant speed;

FIG. 21A is a first diagram for explaining a process for calculating an acceleration vector in a case where the own vehicle is traveling straight forward while accelerating;

FIG. 21B is a second diagram for explaining the process for calculating an acceleration vector in a case where the own vehicle is traveling straight forward while accelerating;

FIG. 21C is a third diagram for explaining the process for calculating an acceleration vector in a case where the own vehicle is traveling straight forward while accelerating;

FIG. 22A is a first diagram for explaining a process for calculating an acceleration vector in a case where the own vehicle is traveling straight forward while decelerating;

FIG. 22B is a second diagram for explaining the process for calculating an acceleration vector in a case where the own vehicle is traveling straight forward while decelerating;

FIG. 22C is a third diagram for explaining the process for calculating an acceleration vector in a case where the own vehicle is traveling straight forward while decelerating;

FIG. 23A is a first diagram for explaining a process for calculating an acceleration vector in a case where the own vehicle turns right;

FIG. 23B is a second diagram for explaining the process for calculating an acceleration vector in a case where the own vehicle turns right;

FIG. 23C is a third diagram for explaining the process for calculating an acceleration vector in a case where the own vehicle turns right;

FIG. 24 is a flow chart showing a detailed example of an operation of step S1600;

FIG. 25 is a flow chart showing a detailed example of an operation of distance measurement in step S1700;

FIG. 26 is a flow chart showing a detailed example of a data integration process in step S1800;

FIG. 27 is a diagram showing an example of a coordinate system of the movable body;

FIG. 28A is a diagram showing an example of output data that is generated by a processing apparatus;

FIG. 28B is a diagram showing another example of output data;

FIG. 29A is a first diagram for explaining a process for generating a vector in a case where the distance measurement system is installed at the right front of the movable body;

FIG. 29B is a second diagram for explaining the process for generating a vector in a case where the distance measurement system is installed at the right front of the movable body;

FIG. 29C is a third diagram for explaining the process for generating a vector in a case where the distance measurement system is installed at the right front of the movable body;

FIG. 29D is a fourth diagram for explaining the process for generating a vector in a case where the distance measurement system is installed at the right front of the movable body;

FIG. 29E is a fifth diagram for explaining the process for generating a vector in a case where the distance measurement system is installed at the right front of the movable body;

FIG. 30 is a diagram showing an example of a predicted relative position of a physical object in a scene in a case where the distance measurement system is installed at the right front of the movable body;

FIG. 31A is a first diagram for explaining a process for generating a vector in a case where the distance measurement system is installed on the right side of the movable body;

FIG. 31B is a second diagram for explaining the process for generating a vector in a case where the distance measurement system is installed on the right side of the movable body;

FIG. 31C is a third diagram for explaining the process for generating a vector in a case where the distance measurement system is installed on the right side of the movable body;

FIG. 31D is a fourth diagram for explaining the process for generating a vector in a case where the distance measurement system is installed on the right side of the movable body;

FIG. 31E is a fifth diagram for explaining the process for generating a vector in a case where the distance measurement system is installed on the right side of the movable body;

FIG. 32A is a first diagram for explaining a process for generating a vector in a case where the distance measurement system is installed at the center rear of the movable body;

FIG. 32B is a second diagram for explaining the process for generating a vector in a case where the distance measurement system is installed at the center rear of the movable body;

FIG. 32C is a third diagram for explaining the process for generating a vector in a case where the distance measurement system is installed at the center rear of the movable body;

FIG. 32D is a fourth diagram for explaining the process for generating a vector in a case where the distance measurement system is installed at the center rear of the movable body;

FIG. 32E is a fifth diagram for explaining the process for generating a vector in a case where the distance measurement system is installed at the center rear of the movable body;

FIG. 33 is a diagram showing an example of a predicted relative position of a physical object in a scene in a case where the distance measurement system is installed at the center rear of the movable body;

FIG. 34A is a first diagram showing an example of a process for calculating an acceleration vector in a case where the distance measurement system is installed at the right front of the movable body and the own vehicle is traveling straight forward while accelerating;

FIG. 34B is a second diagram showing an example of a process for calculating an acceleration vector in a case where the distance measurement system is installed at the right front of the movable body and the own vehicle is traveling straight forward while accelerating;

FIG. 34C is a third diagram showing an example of a process for calculating an acceleration vector in a case where the distance measurement system is installed at the right front of the movable body and the own vehicle is traveling straight forward while accelerating;

FIG. 35A is a first diagram showing an example of a process for calculating an acceleration vector in a case where the distance measurement system is installed at the right front of the movable body and the own vehicle is traveling straight forward while decelerating;

FIG. 35B is a second diagram showing an example of a process for calculating an acceleration vector in a case where the distance measurement system is installed at the right front of the movable body and the own vehicle is traveling straight forward while decelerating;

FIG. 35C is a third diagram showing an example of a process for calculating an acceleration vector in a case where the distance measurement system is installed at the right front of the movable body and the own vehicle is traveling straight forward while decelerating;

FIG. 36A is a first diagram showing an example of a process for calculating an acceleration vector in a case where the distance measurement system is installed at the right front of the movable body and the own vehicle turns right while decelerating;

FIG. 36B is a second diagram showing an example of a process for calculating an acceleration vector in a case where the distance measurement system is installed at the right front of the movable body and the own vehicle turns right while decelerating;

FIG. 36C is a third diagram showing an example of a process for calculating an acceleration vector in a case where the distance measurement system is installed at the right front of the movable body and the own vehicle turns right while decelerating;

FIG. 37A is a first diagram showing an example of a process for calculating an acceleration vector in a case where the distance measurement system is installed on the right side of the movable body and the own vehicle is traveling straight forward while accelerating;

FIG. 37B is a second diagram showing an example of a process for calculating an acceleration vector in a case where the distance measurement system is installed on the right side of the movable body and the own vehicle is traveling straight forward while accelerating;

FIG. 37C is a third diagram showing an example of a process for calculating an acceleration vector in a case where the distance measurement system is installed on the right side of the movable body and the own vehicle is traveling straight forward while accelerating;

FIG. 38A is a first diagram showing an example of a process for calculating an acceleration vector in a case where the distance measurement system is installed on the right side of the movable body and the own vehicle is traveling straight forward while decelerating;

FIG. 38B is a second diagram showing an example of a process for calculating an acceleration vector in a case where the distance measurement system is installed on the right side of the movable body and the own vehicle is traveling straight forward while decelerating;

FIG. 38C is a third diagram showing an example of a process for calculating an acceleration vector in a case where the distance measurement system is installed on the right side of the movable body and the own vehicle is traveling straight forward while decelerating;

FIG. 39A is a first diagram showing an example of a process for calculating an acceleration vector in a case where the distance measurement system is installed on the right side of the movable body and the own vehicle turns right while decelerating;

FIG. 39B is a second diagram showing an example of a process for calculating an acceleration vector in a case where the distance measurement system is installed on the right side of the movable body and the own vehicle turns right while decelerating;

FIG. 39C is a third diagram showing an example of a process for calculating an acceleration vector in a case where the distance measurement system is installed on the right side of the movable body and the own vehicle turns right while decelerating;

FIG. 40A is a first diagram showing an example of a process for calculating an acceleration vector in a case where the distance measurement system is installed at the center rear of the movable body and the own vehicle is traveling straight forward while accelerating;

FIG. 40B is a second diagram showing an example of a process for calculating an acceleration vector in a case where the distance measurement system is installed at the center rear of the movable body and the own vehicle is traveling straight forward while accelerating;

FIG. 40C is a third diagram showing an example of a process for calculating an acceleration vector in a case where the distance measurement system is installed at the center rear of the movable body and the own vehicle is traveling straight forward while accelerating;

FIG. 41A is a first diagram showing an example of a process for calculating an acceleration vector in a case where the distance measurement system is installed at the center rear of the movable body and the own vehicle is traveling straight forward while decelerating;

FIG. 41B is a second diagram showing an example of a process for calculating an acceleration vector in a case where the distance measurement system is installed at the center rear of the movable body and the own vehicle is traveling straight forward while decelerating;

FIG. 41C is a third diagram showing an example of a process for calculating an acceleration vector in a case where the distance measurement system is installed at the center rear of the movable body and the own vehicle is traveling straight forward while decelerating;

FIG. 42A is a first diagram showing an example of a process for calculating an acceleration vector in a case where the distance measurement system is installed at the center rear of the movable body and the own vehicle turns right while decelerating;

FIG. 42B is a second diagram showing an example of a process for calculating an acceleration vector in a case where the distance measurement system is installed at the center rear of the movable body and the own vehicle turns right while decelerating;

FIG. 42C is a third diagram showing an example of a process for calculating an acceleration vector in a case where the distance measurement system is installed at the center rear of the movable body and the own vehicle turns right while decelerating;

FIG. 43 is a block diagram showing an example configuration of the distance measurement apparatus according to a modification;

FIG. 44 is a diagram showing an example of data that is stored by a storage device in the distance measurement apparatus; and

FIG. 45 is a flow chart showing an operation of distance measurement according to the modification.

### DETAILED DESCRIPTIONS

In the present disclosure, all or some of the circuits, units, apparatuses, members, or sections or all or some of the functional blocks in the block diagrams may be implemented as one or more of electronic circuits including, but not limited to, a semiconductor device, a semiconductor integrated circuit (IC), or an LSI (large scale integration). The LSI or IC can be integrated into one chip, or also can be a combination of multiple chips. For example, functional blocks other than a memory may be integrated into one chip. The name used here is LSI or IC, but it may also be called system LSI, VLSI (very large scale integration), or VLSI (ultra large scale integration) depending on the degree of integration. A Field Programmable Gate Array (FPGA) that can be programmed after manufacturing an LSI or a reconfigurable logic device that allows reconfiguration of the connection or setup of circuit cells inside the LSI can be used for the same purpose.

Further, it is also possible that all or some of the functions or operations of the circuits, units, apparatuses, members, or sections are implemented by executing software. In such a case, the software is stored on one or more non-transitory storage media such as a ROM, an optical disk, or a hard disk drive, and when the software is executed by a processor, the software causes the processor together with peripheral devices to execute the functions specified in the software. A system or device may include such one or more non-transitory storage media on which the software is stored and a processor together with necessary hardware devices such as an interface.

In order to measure distances to a plurality of objects scattered about over a wide range in a scene, a conventional distance measurement apparatus uses a method for illuminating the scene thoroughly with a light beam, for example, by raster scanning. With such a method, even an area where no object is present is illuminated with the light beam, and the light beam is emitted in a predetermined order. Therefore, even in the presence of a dangerous or important object in the scene, it is impossible to preferentially emit the object with the light beam. In order to emit the light beam preferentially in a particular direction regardless of order of light emission of scanning, it is necessary to, as disclosed, for example, in Japanese Unexamined Patent Application Publication No. 2018-049014, add a distance measurement apparatus that performs distance measurement preferentially in a certain direction.

Embodiments of the present disclosure provide technologies that make it possible to efficiently acquire distance information on an object without adding a distance measurement apparatus. The following gives a brief overview of the embodiments of the present disclosure.

A control method according to an exemplary embodiment of the present disclosure is a method for controlling a distance measurement apparatus including a light emitting device capable of changing a direction of emission of a light beam and a light receiving device that detects a reflected light beam produced by the emission of the light beam. The method includes acquiring data representing a plurality of images acquired at different points in time by an image sensor that acquires an image of a scene to be subjected to distance measurement, determining, on the basis of the data representing the plurality of images, a degree of priority of distance measurement of one or more physical objects included in the plurality of images, and executing distance measurement of the one or more physical objects by causing the light emitting device to emit the light beam in a direction corresponding to the degree of priority and in an order corresponding to the degree of priority and causing the light receiving device to detect the reflected light beam.

According to the foregoing method, a degree of priority of distance measurement of one or more physical objects included in the plurality of images is determined on the basis of the data representing the plurality of images, and distance measurement of the one or more physical objects is executed by causing the light emitting device to emit the light beam in a direction corresponding to the degree of priority and in an order corresponding to the degree of priority and causing the light receiving device to detect the reflected light beam. Such control makes it possible to efficiently execute distance measurement of a particular physical object having a high degree of priority.

The distance measurement apparatus may be mounted on board a movable body. The method may include acquiring, from the movable body, data representing a movement of the movable body. The degree of priority may be determined on the basis of the data representing the plurality of images and the data representing the movement of the movable body.

The foregoing method makes it possible to determine the degree of priority of the physical object according to a state of movement of the movable body. The movable body may be a vehicle such as an automobile or a two-wheeler. The data representing the movement of the movable body may contain, for example, information such as the velocity, rate of acceleration, or rate of angular acceleration of the movable body. The degree of priority of the physical object cam be more appropriately determine by using not only the data representing the plurality of images but also the data representing the movement of the movable body. For example, on the basis of the velocity or rate of acceleration of the own vehicle and a motion vector of a physical object computed from the plurality of images, the degree of risk of the physical object can be estimated. Flexible control such as setting a high degree of priority for a physical object having a high degree of risk is possible.

Determining the degree of priority may include generating a motion vector of the one or more physical objects on the basis of the plurality of images, generating, on the basis of the data representing the movement of the movable body, a motion vector of a stationary object that is generated due to the movement of the movable body, and determining the degree of priority on the basis of a relative velocity vector that is a difference between the motion vector of the physical object and the motion vector of the stationary object.

According to the foregoing method, for example, as the relative velocity vector becomes greater, the degree of risk of the physical object becomes higher, so that the degree of priority can be made higher. As a result, a dangerous physical object can be intensively and efficiently subjected to distance measurement.

The method may further include, after having executed the distance measurement, outputting, to the movable body, data containing information identifying the physical object and information indicating a distance to the physical object. This allows the movable body to perform an action of, for example, avoiding the physical object.

The degree of priority may be determined on the basis of a magnitude of a time change in the relative velocity vector. The time change in the relative velocity vector represents the rate of acceleration of the physical object. A physical object having a higher rate of acceleration can be determined to be more dangerous and have higher priority. The degree of priority may be determined on the basis of a magnitude of the relative velocity vector.

Acquiring the data representing the plurality of images may include acquiring data representing first, second and third images consecutively acquired by the image sensor. Determining the degree of priority may include generating a first motion vector of the physical object on the basis of the first image and the second image, generating a second motion vector of the physical object on the basis of the second image and the third image, generating, on the basis of the data representing the movement of the movable body, a motion vector of a stationary object that is generated due to the movement of the movable body, generating a first relative velocity vector that is a difference between the first motion vector and the motion vector of the stationary object, generating a second relative velocity vector that is a difference between the second motion vector and the motion vector of the stationary object, and determining the degree of priority on the basis of a difference between the first relative velocity vector and the second relative velocity vector. Such an action makes it possible to determine the degree of priority as appropriate according to a time change in motion vector.

The method may further include repeating more than once a cycle including acquiring the data representing the images, determining the degree of priority of distance measurement of the physical object, and executing the distance measurement of the physical object. A plurality of the cycles may be repeated at regular short time intervals (e.g. approximately few microseconds to few seconds). By repeating determination of the degree of priority and distance measurement, distance measurement of a physical object having a high degree of risk or degree of importance can be appropriately executed even in a traffic environment that changes very rapidly with the passage of time.

For a physical object on which the distance measurement was executed in a cycle, the distance measurement may be continued in a next cycle without determining the degree of priority. In general, it is preferable that distance measurement of a physical object determined to have high priority be continued in the next and subsequent cycles. The foregoing method makes it possible to track the object by skipping determination of the degree of priority and continuing the distance measurement.

The method may further include determining a duration of illumination with the light beam according to the degree of priority. For example, a physical object having a higher degree of priority may be illuminated with the light beam for a longer time. In a case where an indirect TOF method is used as the distance measurement method, the measurable range of distances can be made larger as the duration of illumination with the light beam and the period of exposure of the light receiving device are made longer. For this reason, by lengthening the duration of illumination with the light beam of a physical object having a high degree of priority, the measurable range of distances to the physical object can be extended.

The method may further include determining a number of occurrences of the emission of the light beam and detection of the reflected light beam according to the degree of priority. For example, the number of occurrences may be increased for a physical object having a higher degree of priority. Accuracy of distance measurement can be increased by increasing the number of occurrences. For example, errors in distance measurement can reduced by a process of, for example, averaging results of more than one occurrence of distance measurement.

The light receiving device may include the image sensor. Alternatively, the image sensor may be a device that is independent of the light receiving device.

The image sensor may be configured to acquire the images from light emitted by the light emitting device. In that case, the light emitting device may be configured to emit, separately from the light beam, flush light that illuminates a wide range.

A control apparatus according to another embodiment of the present disclosure controls a distance measurement apparatus including a light emitting device capable of changing a direction of emission of a light beam and a light receiving device that detects a reflected light beam produced by the emission of the light beam. The control apparatus includes a processor and a storage medium having stored thereon a computer program that is executed by the processor. The computer program causes the processor to execute operations including acquiring data representing a plurality of images acquired at different points in time by an image sensor that acquires an image of a scene to be subjected to distance measurement, determining, on the basis of the data representing the plurality of images, a degree of priority of distance measurement of one or more physical objects included in the plurality of images, and executing distance measurement of the one or more physical objects by causing the light emitting device to emit the light beam in a direction corresponding to the degree of priority and in an order corresponding to the degree of priority and causing the light receiving device to detect the reflected light beam.

A system according to still another embodiment of the present disclosure includes the control apparatus, the light emitting device, and the control apparatus.

A computer program according to still another embodiment of the present disclosure is executed by a processor that controls a distance measurement apparatus including a light emitting device capable of changing a direction of emission of a light beam and a light receiving device that detects a reflected light beam produced by the emission of the light beam. The computer program causes the processor to execute operations including acquiring data representing a plurality of images acquired at different points in time by an image sensor that acquires an image of a scene to be subjected to distance measurement, determining, on the basis of the data representing the plurality of images, a degree of priority of distance measurement of one or more physical objects included in the plurality of images, and executing distance measurement of the one or more physical objects by causing the light emitting device to emit the light beam in a direction corresponding to the degree of priority and in an order corresponding to the degree of priority and causing the light receiving device to detect the reflected light beam.

The following describes an exemplary embodiment of the present disclosure. It should be noted that the embodiment to be described below illustrates a general or specific examples. The numerical values, shapes, constituent elements, placement and topology of constituent elements, steps, orders of steps, or other features that are shown in the following embodiment are merely examples and are not intended to limit the present disclosure. Further, those of the constituent elements in the following embodiment which are not recited in an independent claim representing the most generic concept are described as optional constituent elements. Further, the drawings are schematic views and are not necessarily strict illustrations. Furthermore, in the drawings, substantially the same components are given the same reference signs, and a repeated description may be omitted or simplified.

### Embodiment 1

A configuration and operation of a distance measurement system according to exemplary Embodiment 1 of the present disclosure are described.

### 1-1. Configuration

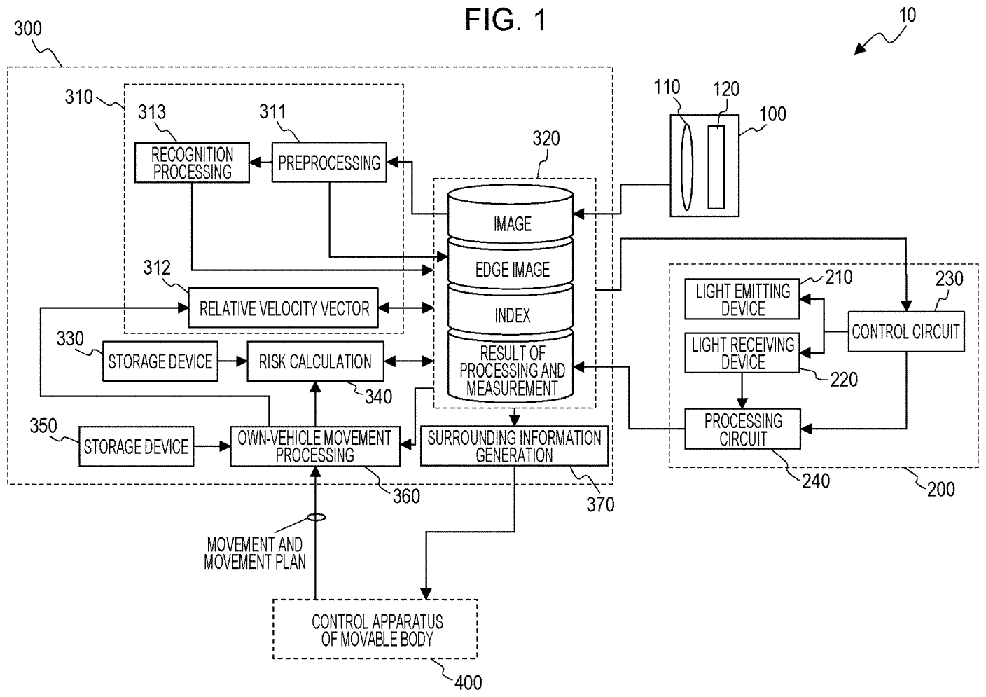

FIG. 1 is a diagram schematically showing a distance measurement system 10 according to exemplary Embodiment 1 of the present disclosure. The distance measurement system 1 may be mounted on board a movable body such as a self-guided vehicle. The movable body includes a control apparatus 400 that controls mechanisms such as an engine, a steering, a brake, and an accelerator. The distance measurement system 10 acquires information on the movement of the movable body and a plan of movement of the movable body from the control apparatus 400 of the movable body and outputs, to the control apparatus 400, information generated regarding a surrounding environment.

The distance measurement system 10 includes an imaging apparatus 100, a distance measurement apparatus 200, and a processing apparatus 300. The imaging apparatus 100 acquires a two-dimensional image by imaging a scene. The distance measurement apparatus 200 emits light, detects reflected light produced by the light thus emitted being reflected by a physical object, and thereby measures the distance to the physical object. The processing apparatus 300 acquires image information acquired by the imaging apparatus 100, distance information acquired by the distance measurement apparatus 200, and movement information and movement plan information that are sent from the control apparatus 400 of the movable body. The processing apparatus 300 generates, on the basis of those pieces of information thus acquired, information regarding the surrounding environment and outputs, to the control apparatus 400, the information regarding the surrounding environment. The information regarding the surrounding environment is hereinafter referred to as “surrounding information”.

### 1-1-1. Imaging Device

The imaging apparatus 100 includes an optical system 110 and an image sensor 120. The optical system 110 includes one or more lenses and forms an image on a photosensitive surface of the image sensor 120. The image sensor 120 is a sensor, such as a CMOS(complementary metal-oxide semiconductor) or a CCD(charge-coupled device), that generates and outputs two-dimensional image data.

The imaging apparatus 100 acquires a luminance image of a scene in the same direction as the distance measurement apparatus 200. The luminance image may be a color image or a black-and-white image. The imaging apparatus 100 may image a scene by means of outside light or may image a scene by illuminating the scene with light from a light source. The light emitted from the light source may be a diffused light, or the whole scene may be imaged by sequentially illuminating the scene with a light beam. The imaging apparatus 100 is not limited to a visible-light camera but may be an infrared camera.

The imaging apparatus 100 performs continuous imaging and generates moving image data in accordance with instructions from the processing apparatus 300.

### 1-1-2. Distance Measurement Apparatus

The distance measurement apparatus 200 includes a light emitting device 210, a light receiving device 220, a control circuit 230, and a processing circuit 240. The light emitting device 210 can emit a light beam in any direction within a predetermined range. The light receiving device 220 receives a reflected light beam produced by the light beam emitted by the light emitting device 210 being reflected by a physical object in a scene. The light receiving device 220 includes an image sensor or one or more photodetectors that detect the reflected light beam. The control circuit 230 controls the timing and direction of emission of the light beam that is emitted from the light emitting device 210 and the timing of exposure of the light receiving device 220. The processing circuit 240 calculates, on the basis of a signal outputted from the light receiving device 220, a distance to an object illuminated with the light beam. The distance can be measured by measuring or calculating the time from emission to reception of the light beam. It should be noted that the control circuit 230 and the processing circuit 240 may be implemented by one integrated circuit.

The light emitting device 210 is a beam scanner capable of changing the direction of emission of the light beam under control of the control circuit 230. The light emitting device 210 can sequentially illuminate some areas within a distance measurement target scene with the light beam. The wavelength of the light beam that is emitted from the light emitting device 210 is not limited to particular wavelengths, but may for example be any wavelength that falls within a visible to infrared range.

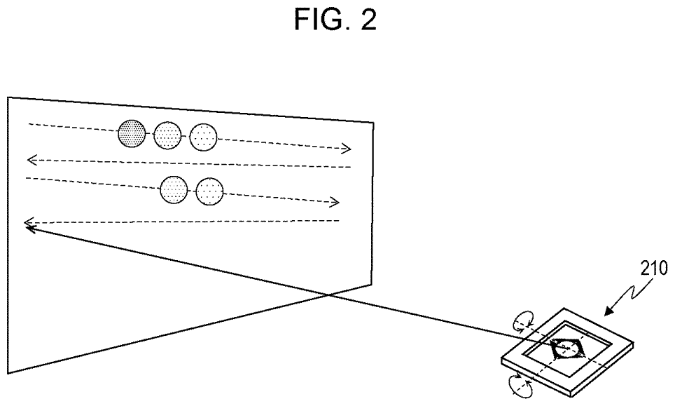

FIG. 2 is a diagram showing an example of the light emitting device 210. In this example, the light emitting device 210 includes a light source that emits a light beam such as a laser and at least one movable mirror, e.g. MEMS mirror. Light emitted from the light source is reflected by the movable mirror and travels toward a predetermined area within a target area (indicated by a rectangle in FIG. 2). The control circuit 230 drives the movable mirror to effect a change in direction of the light emitted from the light emitting device 210. This makes it possible to scan the target area with the light, for example, as indicated by dotted arrows in FIG. 2.

A light source capable of changing the direction of emission of light by means of a structure different from a light emitting device having a movable mirror may be used. For example, as disclosed in Japanese Unexamined Patent Application Publication No. 2018-124271, a light emitting device including a reflective waveguide may be used. Alternatively, a light emitting device that, by adjusting the phase of light that is outputted from each antenna by an antenna array, changes the direction of light of the whole array.

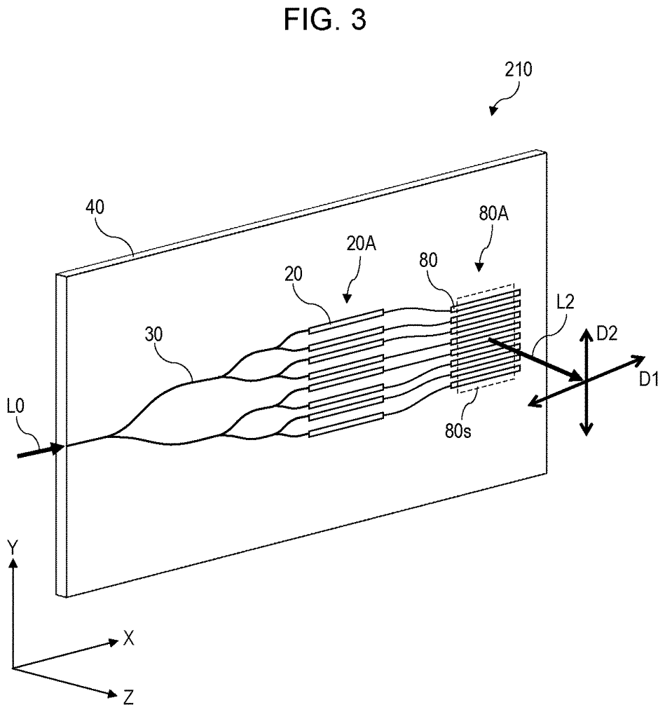

FIG. 3 is a perspective view schematically showing another example of the light emitting device 210. For reference, X, Y, and Z axes orthogonal to one another are schematically shown. The light emitting device 210 includes an optical waveguide array 80A, a phase shifter array 20A, an optical divider 30, and a substrate 40 on which the optical waveguide array 80A, the phase shifter array 20A, the optical divider 30 are integrated. The optical waveguide array 80A includes a plurality of optical waveguide elements 80 arrayed in a Y direction. Each of the optical waveguide elements 80 extends in an X direction. The phase shifter array 20 includes a plurality of phase shifters 20 arrayed in the Y direction. Each of the phase shifters 20 includes an optical waveguide extending in the X direction. The plurality of optical waveguide elements 80 of the optical waveguide array 80A are connected separately to each of the plurality of phase shifters 20 of the phase shifter array 20. The optical divider 30 is connected to the phase shifter array 20A.

Light L0 emitted from a light source such as a laser element is inputted to the plurality of phase shifters 20 of the phase shifter array 20A via the optical divider 30. Light having passed through the plurality of phase shifters 20 of the phase shifter array 20A is inputted to each of the plurality of optical waveguide elements 80 of the optical waveguide array 80A with its phase shifted by certain amounts in the Y direction. Light inputted to each of the plurality of optical waveguide elements 80 of the optical waveguide array 80A is emitted as a light beam L2 from a light exit surface 80s parallel to an X-Y plane in a direction intersecting the light exit surface 80s.

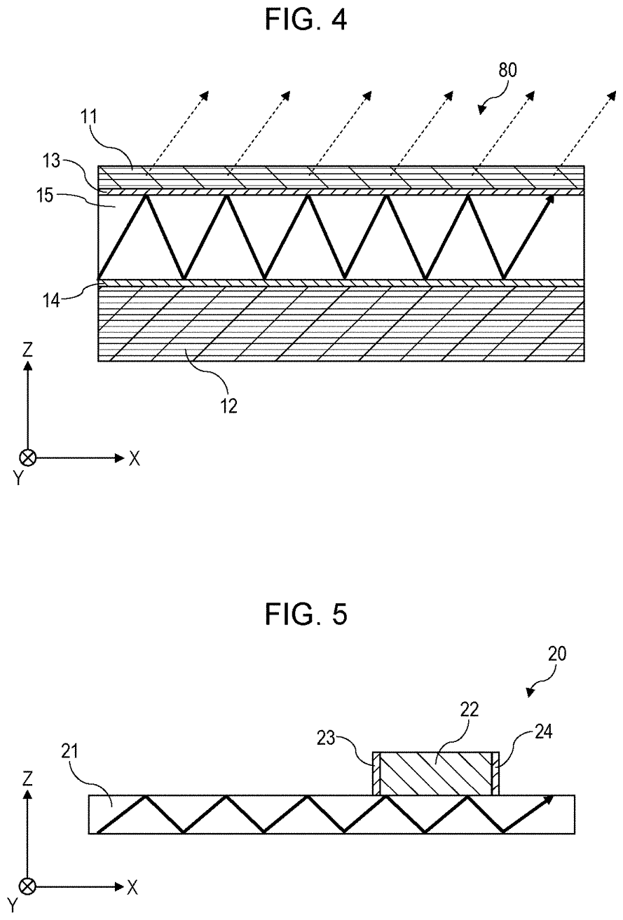

FIG. 4 is a diagram schematically showing an example of a structure of an optical waveguide element 80. The optical waveguide element 80 includes a first mirror 11 and a second mirror 12 that face each other, an optical waveguide layer 15 located between the first mirror 11 and the second mirror 12, and a pair of electrodes 13 and 14 through which a driving voltage is applied to the optical waveguide layer 15. The optical waveguide layer 15 may be constituted by a material, such as a liquid crystal material or an electro-optic material, whose refractive index changes through the application of a voltage. The transmissivity of the first mirror 11 is higher than the transmissivity of the second mirror 12. The first mirror 11 and the second mirror 12 may each be formed, for example, from a multilayer reflecting film in which a plurality of high-refractive-index layers and a plurality of low-refractive-index layers are alternately stacked.

Light inputted to the optical waveguide layer 15 propagates along the X direction through the optical waveguide layer 15 while being reflected by the first mirror 11 and the second mirror 12. An arrow in FIG. 4 schematically represents how the light propagates. A portion of the light propagating through the optical waveguide layer 15 is emitted outward through the first mirror 11.

Applying the driving voltage to the electrodes 13 and 14 causes the refractive index of the optical waveguide layer 15 to change, so that the direction of light that is emitted outward from the optical waveguide element 80 changes. According to changes in the driving voltage, the direction of the light beam L2, which is emitted from the optical waveguide array 80A, changes. Specifically, the direction of emission of the light beam L2 shown in FIG. 3 can be changed along a first direction D1 parallel with the X axis.

FIG. 5 is a diagram schematically showing an example of a phase shifter 20. The phase shifter 20 includes a total reflection waveguide 21 containing a thermo-optic material whose refractive index changes by heat, a heater 22 that makes thermal contact with the total reflection waveguide 21, and a pair of electrodes 23 and 24 through which a driving voltage is applied to the heater 22. The refractive index of the total reflection waveguide 21 is higher than the refractive indices of the heater 22, the substrate 40, and air. The difference in refractive index causes light inputted to the total reflection waveguide 21 to propagate along the X direction through the total reflection waveguide 21 while being totally reflected.

Applying the driving voltage to the pair of electrodes 23 and 24 causes the total reflection waveguide 21 to be heated by the heater 22. This results in a change in the refractive index of the total reflection waveguide 21, so that there is a shift in the phase of light that is emitted from an end of the total reflection waveguide 21. Changing the phase difference in light that is outputted from two adjacent phase shifters 20 of the plurality of phase shifters 20 shown in FIG. 5 allows the direction of emission of the light beam L2 to change along a second direction D2 parallel with the Y axis.

The foregoing configuration allows the light emitting device 210 to two-dimensionally change the direction of emission of the light beam L2. Details such as the principle of operation and method of operation of such a light emitting device 210 are disclosed in Japanese Unexamined Patent Application Publication No. 2018-124271, the entire contents of which are hereby incorporated by reference.

Next, an example configuration of the image sensor of the light receiving device 220 is described. The image sensor includes a plurality of light receiving elements two-dimensionally arrayed along a photosensitive surface. The image sensor may be provided with an optical component facing the photosensitive surface of the image sensor. The optical component may include, for example, at least one lens. The optical component may include another optical element such as a prism or a mirror. The optical component may be designed so that light having diffused from one point on an object in a scene converges at one point on the photosensitive surface of the image sensor.

The image sensor may for example be a CCD (charge-coupled device) sensor, a CMOS (complementary metal-oxide semiconductor) sensor, or an infrared array sensor. Each of the light receiving elements includes a photoelectric conversion element such as a photodiode and one or more charge accumulators. Electric charge produced by photoelectric conversion is accumulated in the charge accumulators during an exposure period. The electric charge accumulated in the charge accumulator is outputted after the end of the exposure period. In this way, each of the light receiving elements outputs an electric signal corresponding to the amount of light received during the exposure period. This electric signal may be referred to as “detection signal”. The image sensor may be a monochrome imaging element, or may be a color imaging element. For example, a color imaging element having an R/G/B, R/G/B/IR or R/G/B/W filter may be used. The image sensor may have detection sensitivity not only to a visible wavelength range but also to a range of wavelengths such as ultraviolet, near-infrared, mid-infrared, or far-infrared wavelengths. The image sensor may be a sensor including a SPAD (single-photon avalanche diode). The image sensor may include an electronic shutter of a mode by which all pixels are exposed en bloc, i.e. a global shutter mechanism. The electronic shutter may be of a rolling-shutter mode by which an exposure is made for each row or of an area shutter mode by which only some areas adjusted to a range of illumination with a light beam are exposed.

With reference to the timing of emission of light from the light emitting device 210, the image sensor receives reflected light in each of a plurality of exposure periods differing in timing of start and end from one each other and outputs, for each exposure period, a signal indicating the amount of light received.

The control circuit 230 determines the direction and timing of emission of light by the light emitting device 210 and outputs a control signal to the light emitting device 210 to instruct the light emitting device 210 to emit light. Furthermore, the control circuit 230 determines the timing of exposure of the light receiving device 220 and outputs a control signal to the light receiving device 220 to instruct the light receiving device 220 to make an exposure and output a signal.

The processing circuit 240 acquires signals, outputted from the light receiving device 220, that indicate electric charge accumulated during a plurality of different exposure periods and, on the basis of those signals, calculates a distance to a physical object. The processing circuit 240 calculates, on the basis of ratios of electric charge accumulated separately in each of the plurality of exposure periods, the time from emission of the light beam from the light emitting device 210 to reception of the reflected light beam by the light receiving device 220 and calculates a distance from the time thus calculated. Such a distance measurement method is referred to as “indirect TOF method”.

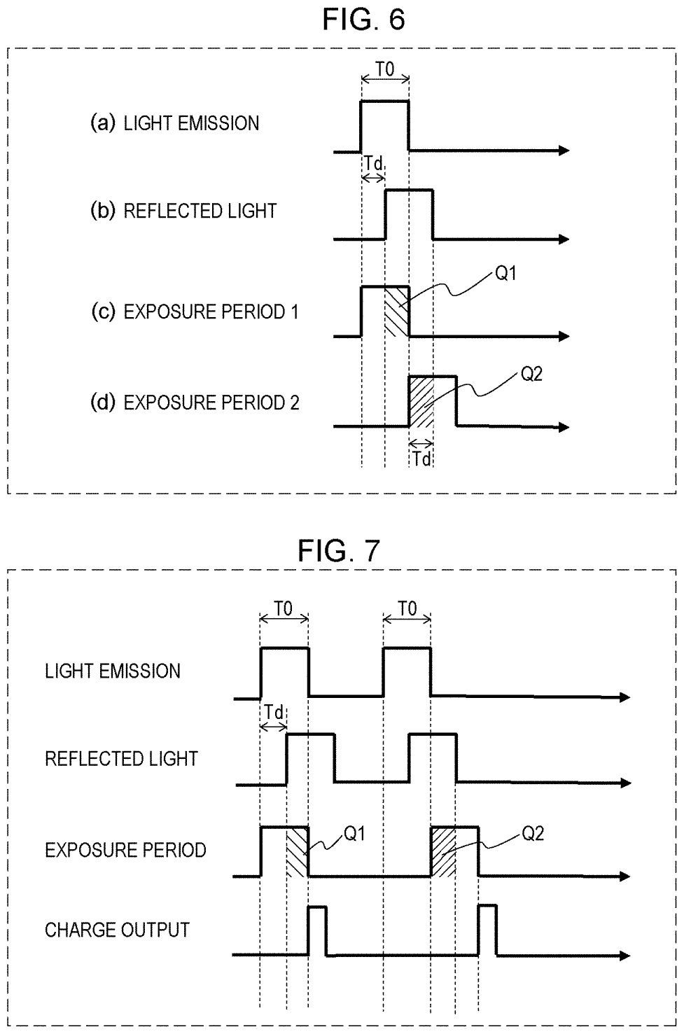

FIG. 6 is a diagram showing examples of the timing of light emission, the timing of arrival of reflected light, and the timings of two exposures in an indirect TOF distance measurement method. The horizontal axis represents time. The rectangular portions represent the respective periods of light emission, arrival of reflected light, and two exposures. For simplicity, this example illustrates an example of a case where one light beam is emitted and a light receiving element that received reflected light produced by the light beam makes two consecutive exposures. (a) of FIG. 6 shows the timing of emission of light from the light source. T0 denotes the pulse duration of a light beam for use in distance measurement. (b) of FIG. 6 shows the period of arrival at the image sensor of the light beam emitted from the light source and reflected off an object. Td denotes the time of flight of the light beam. In the example shown in FIG. 6, the reflected light arrives at the image sensor in a time Td that is shorter than the time duration T0 of the light pulse. (c) of FIG. 6 shows a first exposure period of the image sensor. In this example, an exposure is started at the same time as the start of light emission and ends at the same time as the end of light emission. In the first exposure period, a portion of the reflected light having returned early is photoelectrically converted, and the resulting electric charge is accumulated. Q1 denotes the energy of the light photoelectrically converted during the first exposure period. The energy Q1 is proportional to the amount of electric charge accumulated during the first exposure period. (d) of FIG. 6 shows a second exposure period of the image sensor. In this example, the second exposure period starts at the same time as the end of light emission and ends at a point in time where a period of time equal in length to the pulse duration T0 of the light beam, i.e. a period of time equal in length to the first exposure period, has elapsed. Q2 denotes the energy of light photoelectrically converted during the second exposure period. The energy Q2 is proportional to the amount of electric charge accumulated during the second exposure period. In the second exposure period, a portion of the reflected light having arrived after the end of the first exposure period is received. Since the first exposure period is equal in length to the pulse duration T0 of the light beam, the time duration of the reflected light that is received in the second exposure period is equal to the time of flight Td.

Let it be assumed here that Cfd1 is the integral capacitance of electric charge that is accumulated in the light receiving element during the first exposure period, Cfd2 is the integral capacitance of electric charge that is accumulated in the light receiving element during the second exposure period, Iph is a photoelectric current, and N is a charge transfer clock number. The output voltage of the light receiving element in the first exposure period is expressed by Vout1 as follows:

Vout1=Q1/Cfd1=N×Iph×(T0−Td)/Cfd1

The output voltage of the light receiving element in the second exposure period is expressed by Vout2 as follows:

Vout2=Q2/Cfd2=N×Iph×Td/Cfd2

In the example shown in FIG. 6, since the time length of the first exposure period is equal to the time length of the second exposure period, Cfd1=Cfd2. Accordingly, Td can be expressed by the following formula:

Td={Vout2/(Vout1+Vout2)}×T0

Assuming that C is the velocity of light (≈3×10⁸ m/s), the distance L between the device and the object is expressed by the following formula:

L=1/2×C×Td=1/2×C×{Vout2/(Vout1+Vout2)}×T0

The image sensor, which in actuality outputs electric charge accumulated during an exposure period, may be unable, in terms of time, to make two consecutive exposures. In such a case, for example, a method shown in FIG. 7 is may be used.

FIG. 7 is a diagram schematically showing the timings of light emission, exposure, and charge output in a case where two consecutive exposure periods cannot be provided. In the example shown in FIG. 7, first, the image sensor starts an exposure at the same time as the light source starts emitting light, and the image sensor ends the exposure at the same time as the light source finishes emitting the light. This exposure period is equivalent to “EXPOSURE PERIOD 1” in FIG. 6. Immediately after the exposure, the image sensor outputs electric charge accumulated during this exposure period. This amount of electric charge is equivalent to the energy Q1 of the light received. Next, the light source starts emitting light again and, when a time T0 equal in length to the first light emission elapses, finishes emitting the light. The image sensor starts an exposure at the same time as the light source finishes emitting the light and, when a time length equal to the first exposure period elapses, finishes the exposure. This exposure period is equivalent to “EXPOSURE PERIOD 2” in FIG. 6. Immediately after the exposure, the image sensor outputs electric charge accumulated during this exposure period. This amount of electric charge is equivalent to the energy Q2 of the light received.

Thus, in the example shown in FIG. 7, for the acquisition of signals for the foregoing distance calculation, the light source emits light twice, and the image sensor makes exposures at different timings separately in response to each of those beams of light. This makes it possible to acquire a voltage for each exposure period even in a case where two consecutive exposure periods cannot be provided in terms of time. Thus, in an image sensor that outputs electric charge for each exposure period, information on electric charge that is accumulated during each of a plurality of exposure periods set in advance is obtained by emitting light under the same conditions as many times as the number of exposure periods set.

It should be noted that in actual distance measurement, the image sensor may receive not only light emitted from the light source and reflected by an object but also background light, i.e. extraneous light such as sunlight or surround lighting. Accordingly, in general, an exposure period is provided so that accumulated charge generated by background light falling on the image sensor with no light beam being emitted can be measured in the exposure period. By subtracting, from the amount of electric charge that is measured when a reflection of a light beam is received, the amount of electric charge measured in a background exposure period, the amount of electric charge in a case where the only the reflection of the light beam is received can be obtained. For simplicity, the present embodiment omits a description of an operation concerning background light.

Although, in this example, indirect TOF distance measurement is performed, direct TOF distance measurement may alternatively be performed. In a case where direct TOF distance measurement is performed, the light receiving device 220 includes a sensor including light receiving elements equipped with timer counters and two-dimensionally arranged along a photosensitive surface. The timer counters start measuring time at the start of an exposure and finish measuring time at a point in time where the light receiving elements have received reflected light. In this way, the timer counters measure time separately for each of the light receiving elements to directly measure the time of flight of the light. The processing circuit 240 calculates a distance from the time of flight thus measured of the light.

In the present embodiment, the imaging apparatus 100 and the distance measurement apparatus 200 are separate apparatuses, the functions of the imaging apparatus 100 and the distance measurement apparatus 200 may be integrated into one apparatus. For example, it is possible to use the light receiving device 220 of the distance measurement apparatus 200 instead of the imaging apparatus 100 to acquire a luminance image. The light receiving device 220 may acquire a luminance image without light being emitted from the light emitting device 210, or may acquire a luminance image formed by light emitted from the light emitting device 210. In a case where the light emitting device 210 emits the light beam, a luminance image of the whole scene may be generated by storing luminance images of parts of the scene as sequentially acquired by a plurality of the light beams and integrating the luminance images. Alternatively, a luminance image of the whole scene may be generated by making a continuous exposure while sequentially emitting the light beam. The light emitting device 210 may emit, separately from the light beam, light that diffuses over a wide range, whereby the light receiving device 220 may acquire a luminance image.

### 1-1-3. Processing Apparatus

The processing apparatus 300 is a computer connected to the imaging apparatus 100, the distance measurement apparatus 200, and the control apparatus 400. The processing apparatus 300 includes a first storage device 320, a second storage device 330, a third storage device 350, an image processing module 310, a risk calculation module 340, an own-vehicle movement processing module 360, and a surrounding information generation module 370. The image processing module 310, the risk calculation module 340, the own-vehicle movement processing module 360, and the surrounding information generation module 370 may be implemented by one or more processors. By executing a computer program stored on a storage medium, a processor of the processing apparatus 300 may function as the image processing module 310, the risk calculation module 340, the own-vehicle movement processing module 360, and the surrounding information generation module 370.

The image processing module 310 processes an image outputted by the imaging apparatus 100. The first storage device 320 has stored therein data such as an image acquired by the imaging apparatus 100 and a processing result generated by the processing apparatus 300, with the image and the processing result being associated with each other. The processing result contains, for example, information such as the degree of risk of an object in a scene. The second storage device 330 has stored therein a predetermined conversion table or function that is used in a process that is executed by the risk calculation module 340. The risk calculation module 340 calculates the degree of risk of an object in a scene with reference to the conversion table or function stored in the second storage device 330. The risk calculation module 340 calculates the degree of risk of an object on the basis of the relative velocity vector and acceleration vector of the object. The own-vehicle movement processing module 360 generates, on the basis of an image processing result and a risk calculation result stored in the first storage device 320 and movement information and movement plan information acquired from the movable body and with reference to data stored in the third storage device 350, information regarding the movement and processing of the movable body. The surrounding information generation module 370 generates surrounding information on the basis of an image processing result stored in the first storage device 320, a risk calculation result, and information regarding the movement and processing of the movable body.

The image processing module 310 includes a preprocessing module 311, a relative velocity vector module 312, and a recognition processing module 313. The preprocessing module 311 performs an initial signal process on image data generated by the imaging apparatus 100. The relative velocity vector module 312 calculates the motion vector of a physical object in a scene on the basis of an image acquired by the imaging apparatus 100. The relative velocity vector module 312 further generates the relative velocity vector of the physical object from the motion vector thus calculated and an apparent motion vector based on own-vehicle movement. The recognition processing module 313 recognizes one or more physical objects from an image processed by the preprocessing module 311.

In the example shown in FIG. 1, the first storage device 320, the second storage device 330, and the third storage device 350 are expressed as three separate storage devices. However, these storage devices 320, 330, and 350 may be implemented by a single storage device, or may be implemented by two or four or more storage devices. Further, although, in this example, the processing circuit 240 and the processing apparatus 300 are separate from each other, they may be implemented by one apparatus or circuit. Furthermore, the processing circuit 240 and the processing apparatus 300 may each be a constituent element of the movable body. The processing circuit 240 and the processing apparatus 300 may each be implemented by an aggregate of a plurality of circuits.

The following describes a configuration of the processing apparatus 300 in more detail.

The preprocessing module 311 performs signal processes such as noise reduction, edge extraction, and signal enhancement on a series of image data generated by the imaging apparatus 100. These signal processes are referred to as “preprocessing”.

The relative velocity vector 312 calculates the respective motion vectors of one or more physical objects in a scene on the basis of a series of image data subjected to preprocessing. The relative velocity vector module 312 calculates a motion victor for each physical object in a scene on the basis of a plurality of images acquired at different points in time within a certain period of time, i.e. a plurality of frames of image at different timings in a moving image. The relative velocity vector module 312 generates a movement vector based on the movable body that was generated by the own-vehicle movement processing module 360. The movement vector based on the movable body is the apparent movement vector of a stationary object that is generated due to the movement of the movable body. The relative velocity vector module 312 generates a relative velocity vector from the difference between a motion vector calculated for each physical object in a scene and an apparent movement vector based on the movement of the own vehicle. The relative velocity vector may be generated, for example, for each feature point such as a point of inflection on an edge of each physical object.

The recognition processing module 313 recognizes one or more physical objects from each frame of image processed by the preprocessing module 311. This recognition processing may include a process of extracting a movable object such as a vehicle, a person, or a bicycle or a stationary object in a scene, for example, from an image and outputting an area of the image as a rectangular area. As a method of recognition, any method such as machine learning or pattern matching may be used. An algorithm for the recognition processing is not limited to a particular one, but any algorithm may be used. For example, in a case where learning and recognition of a physical object by machine learning are performed, a previously-trained learned model is stored on a storage medium. Applying the learned model to each frame of image data inputted makes it possible to extract a physical object such as a vehicle, a person, or a bicycle.

The storage device 320 has stored therein a variety of data generated by the imaging apparatus 100, the distance measurement apparatus 200, and the processing apparatus 300. For example, the storage device 320 has stored therein the following data:

Image data generated by the imaging apparatus 100.
Preprocessed image data, data on a relative velocity vector, and data representing a result
of recognition of a physical object; generated by the image processing module 310. Data representing a degree of risk for each physical object calculated by the risk calculation module 340.
Distance data for each physical object generated by the distance measurement apparatus 200.

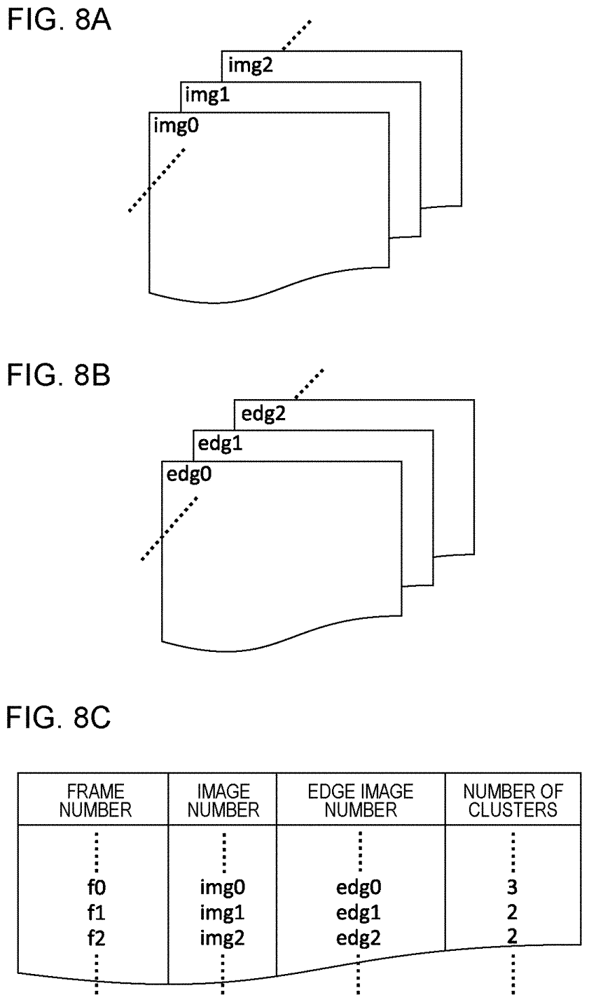

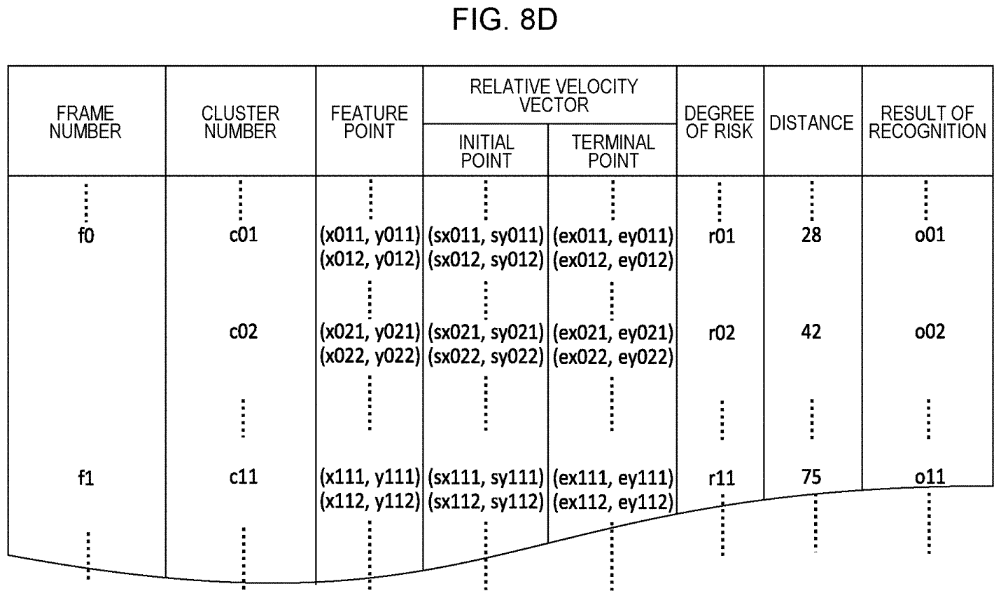

FIGS. 8A to 8D are diagrams each showing an example of data that is stored in the first storage device 320. In this example, a database is created with reference to frames of moving image acquired by the imaging apparatus 100 and clusters, generated by the processing apparatus 300, each of which indicates an area of a physical object recognized in an image. FIG. 8A shows a plurality of frames of moving image generated by the imaging apparatus 100. FIG. 8B shows a plurality of edge images generated by the preprocessing module 311 performing preprocessing on the plurality of frames. FIG. 8C shows a table of number of each frame, number of image data generated by the imaging apparatus 100, number of edge image generated by the preprocessing module 311, and number of clusters each representing area of physical object in image. FIG. 8D shows a table of number of each frame, identification number of each cluster, coordinates of feature point (such as a point of inflection on an edge) included in each cluster, coordinates of initial and terminal points of relative velocity vector for each feature point, degree of risk calculated for each cluster, distance calculated for each cluster, and ID of physical object recognized.

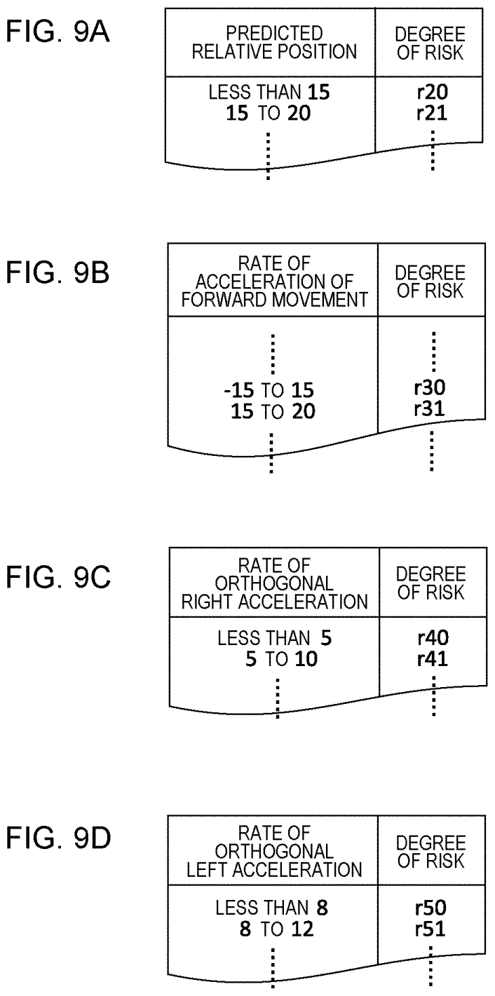

The storage device 330 has stored therein a predetermined correspondence table or function for risk calculation and parameters thereof. FIGS. 9A to 9D are diagrams each showing an example of data that is stored in the storage device 330. FIG. 9A shows a correspondence table of predicted relative position and degree of risk. FIG. 9B shows a correspondence table of rate of acceleration of forward movement during acceleration and during deceleration and degree of risk. FIG. 9C shows a correspondence table of rate of acceleration during right turn and degree of risk. FIG. 9D shows a correspondence table of rate of acceleration during left turn and degree of risk. The risk calculation module 340 calculates a degree of risk from the predicted relative position and rate of acceleration of each physical object in a scene with reference to the correspondence relationship between position and degree of risk and the correspondence relationship between rate of acceleration and degree of risk stored in the storage device 330. It should be noted that the storage device 330 may have stored therein in the form of functions as well as in the form of correspondence tables the correspondence relationship between position and degree of risk and the correspondence relationship between rate of acceleration and degree of risk.

The risk calculation module 340 estimates, according to a relative velocity vector for each edge feature point calculated by the relative velocity vector module 312, the predicted relative position of a physical object including an edge feature point. The predicted relative position is a position where the physical object will be present after a predetermined period of time. The predetermined period of time may for example be set to be equal in length of time to an inter-frame spacing. The risk calculation module 340 determines, on the basis of the correspondence table of predicted relative position and degree of risk stored in the storage device 330 and the magnitude of the relative velocity vector, a degree of risk corresponding to the predicted relative position thus calculated. Meanwhile, the risk calculation module 340 calculates the acceleration vector of own-vehicle movement on the basis of a plan of movement of the own vehicle generated by the own-vehicle movement processing module 360. In a case where the absolute value of the acceleration vector is greater than a predetermined magnitude, the risk calculation module 340 calculates a degree of risk entailed in the turning and acceleration/deceleration of the own vehicle. The risk calculation module 340 obtains an orthogonal component and a straight-forward component of the acceleration vector. In a case where the absolute value of the orthogonal component is greater than a predetermined threshold, the risk calculation module 340 refers to the correspondence table shown in FIG. 9C or 9D, extracts a degree of risk concerning a component of the relative velocity vector acting in the direction in which acceleration turns, and combines the degree of risk with the degree of risk determined according to the predicted relative position. On the other hand, in a case where the absolute value of the straight-forward component of the acceleration vector is greater than a predetermined threshold, the risk calculation module 340 refers to the correspondence table shown in FIG. 9B, extracts a degree of risk concerning the value of a component of the relative velocity vector acting toward the own vehicle, and combines the degree of risk with the degree of risk determined according to the predicted relative position.

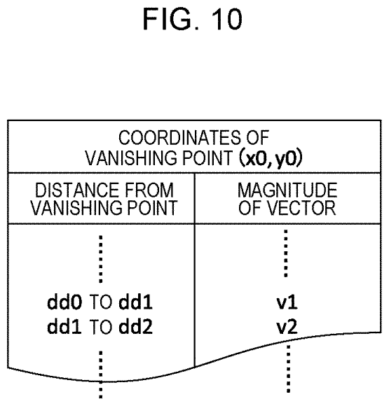

The storage device 350 has stored therein a correspondence table showing a relationship between position of physical object in image and magnitude of apparent motion vector. FIG. 10 is a diagram showing an example of a correspondence table that is stored in the storage device 350. In the example shown in FIG. 10, the storage device 350 has stored therein the coordinates of a point corresponding to a vanishing point of a one-point perspective view in an image acquired by the imaging apparatus 100 and a correspondence table of distance from coordinates to physical object and magnitude of motion vector. Although, in this example, the relationship between distance from vanishing point and magnitude of motion vector is stored in the form of a table, the relationship may be stored in the form of a relational expression.

The own-vehicle movement processing module 360 acquires, from the control apparatus 400 of the movable body mounted with the distance measurement system 10, movement information on the movement of the movable body made between a preceding frame f0 and a current frame f1 and movement plan information. The movement information contains information on the velocity or rate of acceleration of the movable body. The movement plan information contains information indicating a future movement of the movable body, e.g. information such as forward movement, a right turn, a left turn, acceleration, or deceleration. The own-vehicle movement processing module 360 generates, with reference to the data stored in the storage device 350 and from the movement information thus acquired, an apparent motion vector that is generated by the movement of the movable body. Further, the own-vehicle movement processing module 360 generates, from the movement plan information thus acquired, the acceleration vector of the own vehicle in a next frame f2. The own-vehicle movement processing module 360 outputs, to the risk calculation module 340, the apparent motion vector thus generated and the acceleration vector thus generated of the own vehicle.

The control apparatus 400 acquires movement information and movement plan information from a self-guided vehicle system, a navigation system, or other various on-board sensors mounted on board the own vehicle. The other on-board sensors may include a steering sensor, a velocity sensor, an acceleration sensor, a GPS, and a driver monitoring sensor. The movement plane information is for example information that indicates a next movement of the own vehicle that is determined by the self-guided vehicle system. Another example of the movement plan information is information that indicates a next movement of the own vehicle predicted on the basis of a scheduled traveling route acquired from the navigation system and information from the other on-board sensors.

### 1-2. Operation

Next, an operation of the distance measurement system 10 is described in more detail.

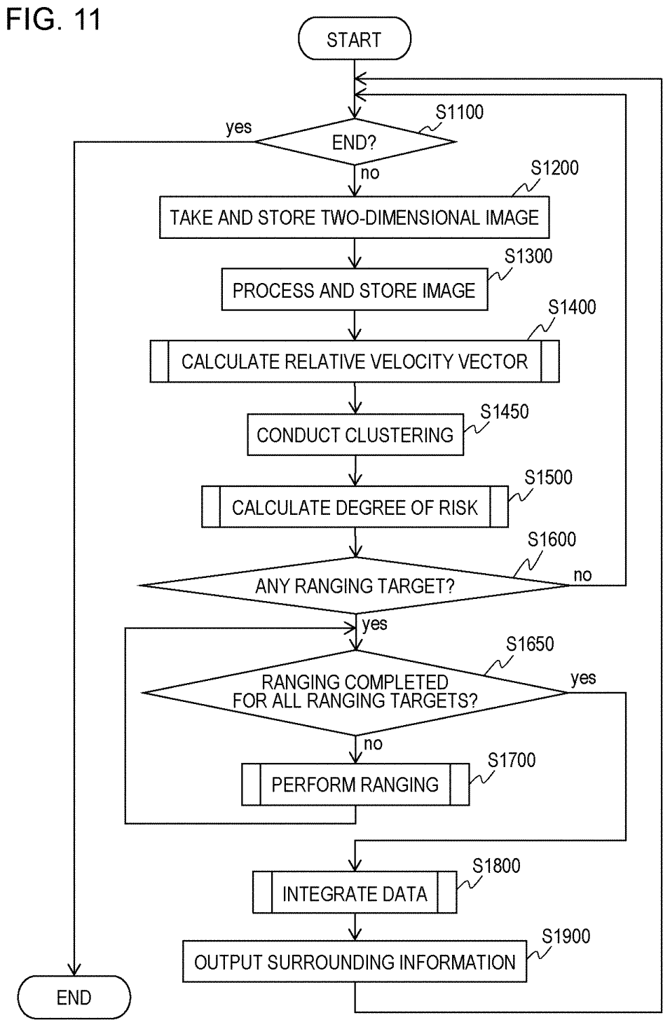

FIG. 11 is a flow chart presenting an overview of an operation of the distance measurement system 10 according to the present embodiment. The distance measurement system 10 executes an operation made up of steps S1100 to S1900 shown in FIG. 11. The following describes the action of each step.

### Step S1100

The processing apparatus 300 determines whether an end signal has been inputted from input means, e.g. the control apparatus 400 shown in FIG. 1 or an input device (not illustrated). In a case where an end signal has been inputted, the processing apparatus 300 ends the operation. In a case where no end signal has been inputted, the operation proceeds to step S1200.

### Step S1200

The processing apparatus 300 instructs the imaging apparatus 100 to take a two-dimensional image of a scene. The imaging apparatus 100 generates two-dimensional image data and outputs it to the storage device 320 of the processing apparatus 300. As shown in FIG. 8C, the storage device 320 stores, in association with a frame number, the two-dimensional image data thus acquired.

### Step S1300

The preprocessing module 311 of the processing apparatus 300 performs preprocessing of the two-dimensional image acquired by the imaging apparatus 100 and stored in the storage device 320 in step S1200. The preprocessing includes, for example, a filter noise reduction process, an edge extraction process, and an edge enhancement process. The preprocessing may be a process other than these processes. The preprocessing module 311 stores a result of the preprocessing in the storage device 320. In the examples shown in FIGS. 8B and 8C, the preprocessing module 311 generates an edge image by preprocessing. The storage device 320 stores the edge image in association with the frame number. The preprocessing module 311 also extracts one or more feature points from an edge in the edge image and stores the feature points in association with the frame number. The feature points may for example be points of inflection on the edge in the edge image.

### Step S1400

The relative velocity vector module 312 of the processing apparatus 300 generates a relative velocity vector using a most recent frame f1 of two-dimensional image processed in step S1300 and an immediately preceding frame f0 of two-dimensional image processed in step S1300. The relative velocity vector module 312 performs matching between a feature point set in the most recent frame f1 of image and stored in the storage device 320 and a feature point set in the immediately preceding frame f0 of image and stored in the storage device 320. For the feature points thus matched, a vector connecting the position of the feature point in the frame f0 with the position of the feature point in the frame f1 is extracted as a motion vector. The relative velocity vector module 312 calculates a relative velocity vector by subtracting, from the motion vector, a vector based on own-vehicle movement calculated by the own-vehicle movement processing module 360. The relative velocity vector thus calculated is associated with the feature point in the frame f1 used for the calculation of the relative velocity vector, and is stored in the storage device 320 in such a form as to describe the coordinates of the initial and terminal points of the vector. A method for calculating a relative velocity vector will be described in detail later.

### Step S1450

The relative velocity vector module 312 conducts a clustering of a plurality of relative velocity vectors calculated in step S1400. This clustering is based on the directions and magnitudes of the vectors. For example, the relative velocity vector module 312 conducts the clustering on the basis of the differences between the initial and terminal points of the vectors in an x-axis direction and the differences between the initial and terminal points of the vectors in an y-axis direction. The relative velocity vector module 312 assigns a number to an extracted cluster and associates the cluster with the current frame f1. As shown in FIG. 8D, an extracted cluster is stored in the storage device 320 in such a form as to be associated with the relative velocity vector of the cluster. Each cluster corresponds to one physical object.

### Step S1500

The risk calculation module 340 of the processing apparatus 300 calculates a predicted relative position in the next frame f2 on the basis of a relative velocity vector stored in the storage device 320. The risk calculation module 340 calculates a degree of risk using a relative velocity vector in the same cluster whose predicted relative position is nearest to the position of the own vehicle. According to the predicted relative position, the risk calculation module 340 calculates a degree of risk with reference to the storage device 330. Meanwhile, the risk calculation module 340 generates an acceleration vector on the basis of a plan of movement of the own vehicle inputted from the control apparatus 400 of the movable body and calculates a degree of risk according to the acceleration vector. The risk calculation module 340 calculates an overall degree of risk of the cluster by integrating the degree of risk calculated on the basis of the predicted relative position and the degree of risk calculated on the basis of the acceleration vector. As shown in FIG. 8D, the storage device 320 stores the degree of risk for each cluster. A method for calculating a degree of risk will be described in detail later.

### Step S1600

The control circuit 230 of the distance measurement apparatus 200 refers to the storage device 320 and determines the presence or absence of a distance measurement target according to a degree of risk for each cluster. For example, in a case where there is a cluster whose degree of risk is higher than a threshold, the presence of a distance measurement target is determined. In the absence of a distance measurement target, the operation returns to step S1100. In the presence of one or more distance measurement targets, the operation proceeds to step S1650. For clusters associated with the current frame f1, distance measurement of a cluster, i.e. a physical object, having a relative velocity vector with a high degree of risk is preferentially performed. For example, the processing apparatus 300 determines, as a distance measurement target, a range of positions in a next frame as predicted from the relative velocity vector of each cluster to be subjected to distance measurement. As distance measurement targets, for example, a given number of clusters may be determined in descending order of degree of risk. Alternatively, a plurality of clusters may be determined in descending order of degree of risk until the proportion of a total of ranges of predicted positions of clusters to a two-dimensional space serving as a range of imaging of the light receiving device 220 exceeds a certain value.

### Step S1650

The control circuit 230 determines whether distance measurement has been completed for all clusters to be subjected to distance measurement. In a case where distance measurement has not been completed for all clusters to be subjected to distance measurement, the operation proceeds to step S1700. In a case where distance measurement has been completed for all clusters to be subjected to distance measurement, the operation proceeds to step S1800.

### Step S1700

The control circuit 230 executes distance measurement for one of the clusters determined as distance measurement targets in step S1600 that is yet to be subjected to distance measurement. For example, of the clusters determined as distance measurement targets and yet to be subjected to distance measurement, a cluster, i.e. a physical object, having the highest degree of risk may be determined as a distance measurement target. The control circuit 230 sets the direction of emission of the light beam so that a range corresponding to the cluster is illuminated. For example, a direction toward a predicted relative position corresponding to a feature point in the cluster may be set as the direction of emission of the light beam. The control circuit 230 sets the timing of emission of the light beam from the light emitting device 210 and the timing of exposure of the light receiving device 220 and outputs the respective control signals to the light emitting device 210 and the light receiving device 220. Upon receiving the control signal, the light emitting device 210 emits the light beam in a direction indicated by the control signal. Upon receiving the control signal, the light receiving device 220 starts an exposure and detects reflected light from the physical object. Each light receiving element of the image sensor of the light receiving device 220 outputs, to the processing circuit 240, a signal indicating electric charge accumulated within each exposure period. The processing circuit 240 calculates a distance by the aforementioned method for a pixel, included in the range of illumination with the light beam, in which electric charge was accumulated during an exposure period.

The processing circuit 240 outputs the distance thus calculated to the storage device 320 in association with a cluster number. As shown in FIG. 8D, the storage device 320 stores a result of distance measurement in such a form that the result of distance measurement is associated with a cluster. After completion of distance measurement and data storage in step S1700, the operation returns to step S1650.

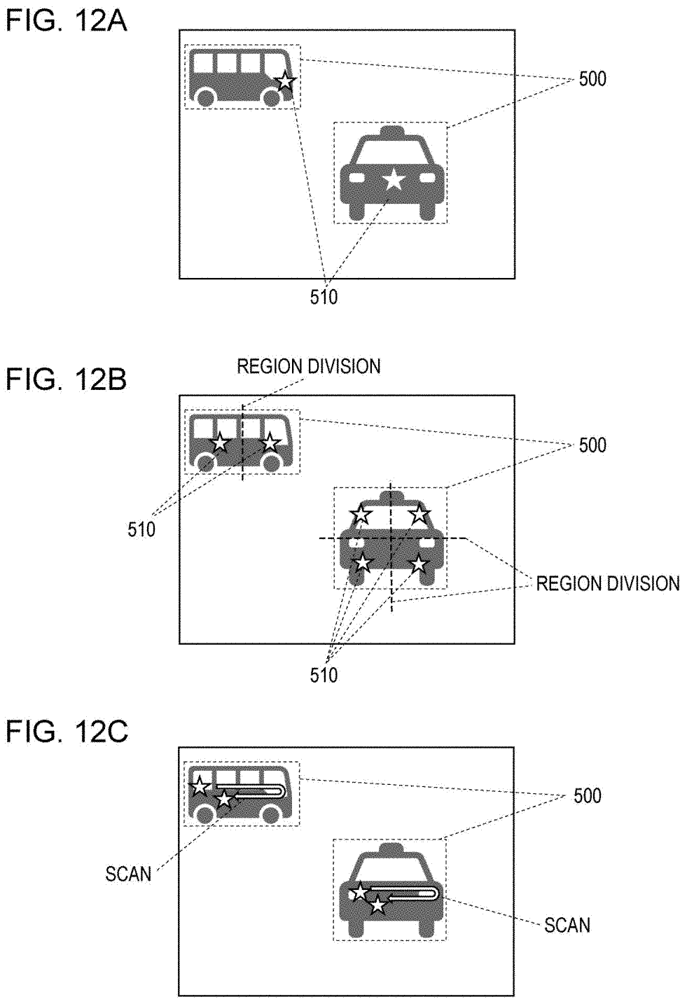

FIGS. 12A to 12C are diagrams each showing an example of a distance measurement method for each cluster. In the example described above, as shown in FIG. 12A, one feature point 510 is selected for each cluster 500, and the light beam is emitted in that direction. In a case where a range corresponding to a cluster 500 exceeds a range of illumination with a single light beam, a two-dimensional region of each cluster 500 may be divided into a plurality of partial areas as shown in FIG. 12B so that the partial areas may each be separately illuminated with the light beam. Such a method makes it possible to measure distances separately for each of the partial areas. The order in which the partial areas thus divided are each separately illuminated with the light beam may be arbitrarily determined. Alternatively, as shown in FIG. 12C, a range corresponding to a two-dimensional region of each cluster 500 may be scanned with the light beam. A scan direction and a scan trajectory may be arbitrarily determined. Such a method makes it possible to measure a distance for each pixel corresponding to the scan trajectory.

### Step S1800

The surrounding information generation module 370 of the processing apparatus 300 refers to the storage device 320 and integrates, for each cluster, a result of image recognition by the recognition processing module 313 and a distance stored for each cluster. A method for integrating data will be described in detail later.

### Step S1900

The surrounding information generation module 370 converts the data integrated in step S1800 into output data and outputs the output data to the control apparatus 400 of the movable body. The output data will be described in detail later. This output data is referred to as “surrounding information”. After the data output, the operation returns to step S1100.

By repeating the operation from step S1100 to step S1900, the distance measurement system 10 repeatedly generates information on the surrounding environment that is used for the movable body to move.

The control apparatus 400 of the movable body executes control of the movable body on the basis of the surrounding information outputted by the distance measurement system 10. An example of the control of the movable body is automatically controlling mechanisms such as an engine, a motor, a steering, a brake, and an accelerator of the movable body. The control of the movable body may be providing, to a driver who drives the movable body, information needed for driving or may be alerting the driver. The information may be provided to the driver by an output device, such as a head-up display or a speaker, mounted on board the movable body.

In the example shown in FIG. 11, the distance measurement system 10 performs the operation from step S1100 to step S1900 for each frame that the imaging apparatus 100 generates. However, the operation of information generation by distance measurement may be performed once per multiple frames. For example, the action of step S1400 may be followed by an additional step of determining whether to execute the subsequent actions. For example, distance measurement and generation of surrounding information may be performed only in a case where the rate of acceleration of a physical object is higher than or equal to a predetermined value. More specifically, the processing apparatus 300 may compare a relative velocity vector in a scene calculated in the current frame f1 with a relative velocity vector in a scene calculated for the immediately preceding frame f0. In a case where for all clusters in the frame f1, the difference in magnitude of a relative velocity vector corresponding to the same cluster in the frame f0 is smaller than a predetermined value, the operation from step S1450 to step S1800 may be skipped. In that case, the operation may return to step S1100 on the assumption that there is no change in the surrounding situation, or the operation may return to step S1100 after only relative velocity vector information has been outputted to the control apparatus 400 of the movable body.

### 1-2-1. Calculation of Relative Velocity Vector

Next, the calculation of a relative velocity vector in step S1400 is described in detail.

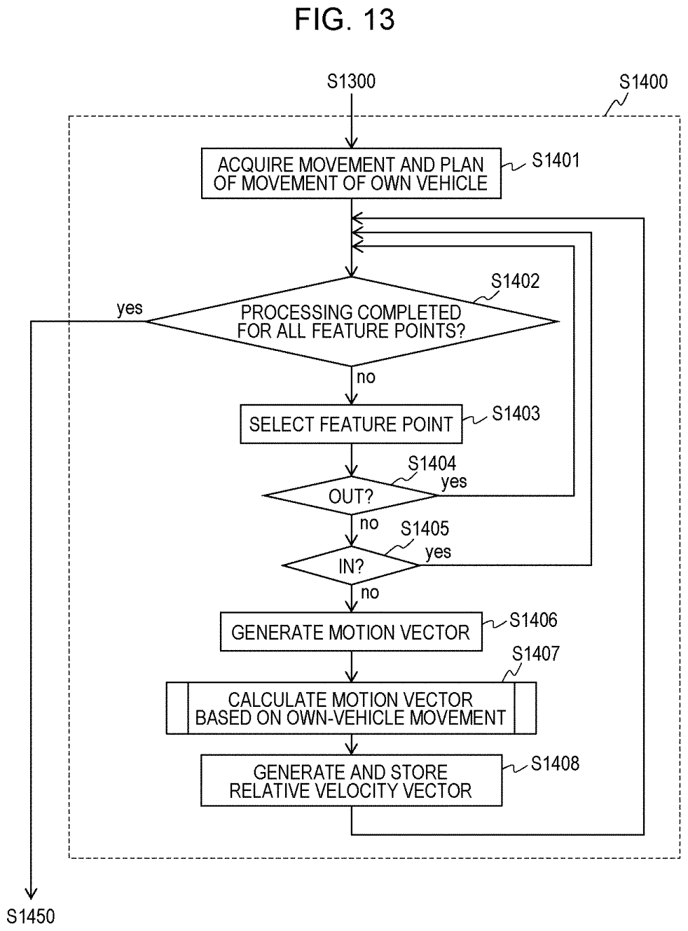

FIG. 13 is a flow chart showing details of the action of step S1400 in FIG. 11. Step S1400 includes an operation made up of steps S1401 to S1408 shown in FIG. 13. The following describes the action of each step.

### Step S1401

The own-vehicle movement processing module 360 of the processing apparatus 300 acquires, from the control apparatus 400 of the movable body, information on the movement of the movable body during a period from the time of acquisition of the immediately preceding frame f0 to the time of acquisition of the current frame f1. The information on the movement may contain, for example, the travel speed of the vehicle and information on the direction and distance of movement during the period from the timing of the immediately preceding frame f0 to the timing of the current frame f1. Furthermore, the own-vehicle movement processing module 360 acquires, from the control apparatus 400, information indicating a plan of movement of the movable body during a period from the timing of the current frame f1 to the timing of the next frame f2, e.g. a control signal to an actuator. The control signal to the actuator may for example be a signal that gives an instruction to perform an action such as acceleration, deceleration, a right turn, or a left turn.

### Step S1402

The relative velocity vector module 312 of the processing apparatus 300 refers to the storage device 320 and determines whether a matching process has been completed for all feature points in the immediately preceding frame f0 of image and all feature points in the current frame f1 of image. In a case where the matching process has been completed for all feature points, the operation proceeds to step S1450. In a case where the matching process has not been completed for all feature points, the operation proceeds to step S1403.

### Step S1403

The relative velocity vector module 312 selects, from among the feature points extracted in the current frame f0 of image and stored in the storage device 320 and the feature points extracted in the current frame f1 of image and stored in the storage device 320, a point yet to be subjected to the matching process. The selection is preferentially carried out for the feature points in the immediately preceding frame f0.

### Step S1404

The relative velocity vector module 312 performs matching between the feature point selected in step S1403 and a feature point in a frame different from the image in which the feature point is included. The relative velocity vector module 312 determines whether in the period of time from the immediately preceding frame f0 to the current frame f1, a physical object having the feature point or the position on a physical object that corresponds to the feature point has gone out of sight of the imaging apparatus 100, i.e. the angle of view of the image sensor. In a case where the feature point selected in step S1403 is a feature point in the immediately preceding frame f0 of image and there is no corresponding feature point among the feature points in the current frame f1 of image, the determination is “yes” in step S1404. That is, in a case where there is no feature point in the current frame f1 of image that corresponds to a feature point in the immediately preceding frame f0 of image, it is determined that a position corresponding to the feature point has gone out of sight of the imaging apparatus 100 in the period of time from the immediately preceding frame f0 to the current frame f1. In that case, the operation returns to step S1402. On the other hand, in a case where the feature point selected in step S1403 is not a feature point in the immediately preceding frame f0 of image or in a case where the feature point selected is a feature point in the immediately preceding frame f0 of image and there is a corresponding feature point in the current frame f1 of image, the operation proceeds to step S1405.

### Step S1405

The relative velocity vector module 312 performs matching between the feature point selected in step S1403 and a feature point in a frame different from the image in which the feature point is included. The relative velocity vector module 312 determines whether in the period of time from the immediately preceding frame f0 to the current frame f1, a physical object having the feature point or the position on a physical object that corresponds to the feature point has come into sight of the imaging apparatus 100 or has come to occupy a discriminably-large area. In a case where the feature point selected in step S1403 is a feature point in the current frame f1 of image and there is no corresponding feature point in the immediately preceding frame f0 of image, the determination is “yes” in step S1405. That is, in a case where there is no feature point in the immediately preceding frame f0 of image that corresponds to a feature point in the current frame f1 of image, it is determined that the feature point is a feature point of a physical object having first appeared in sight of the imaging apparatus 100 in the current frame f1. In that case, the operation returns to step S1402. On the other hand, in the case of successful matching between a feature point in the current frame f1 of image and a feature point in the immediately preceding frame f0 of image, the operation proceeds to step S1406.

### Step S1406

The relative velocity vector module 312 generates a motion vector for a feature point selected in step S1403 and identified as a specific feature point included in the same physical object in both the current and immediately preceding frames f1 and f0 of image. The motion vector is a vector connecting the position of the feature point in the immediately preceding frame f0 of image with the position of the corresponding feature point in the current frame f1 of image.

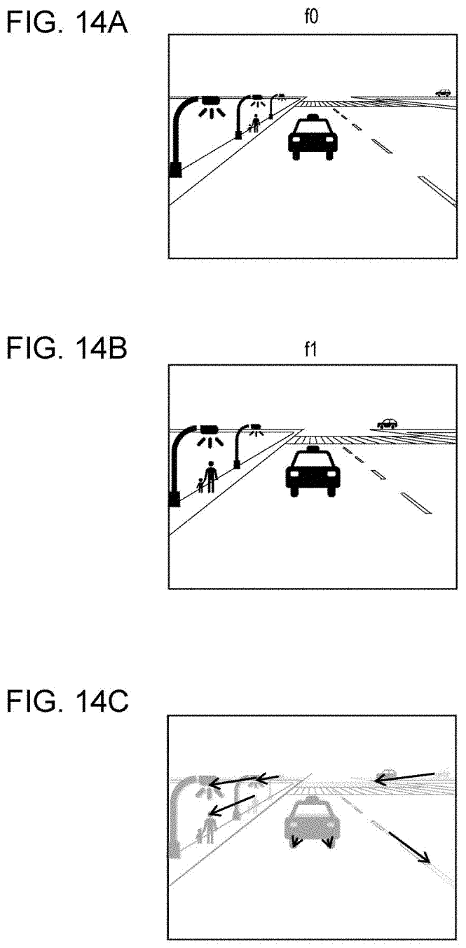

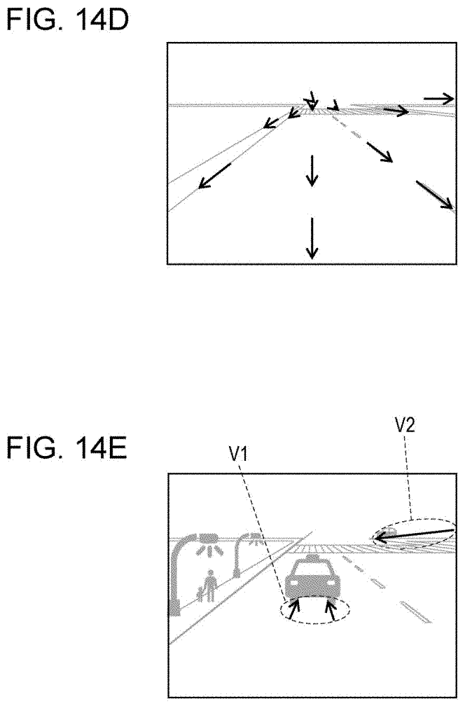

FIGS. 14A to 14C are diagrams each schematically showing the action of step S1406. FIG. 14A is a diagram showing an example of the immediately preceding frame f0 of image. FIG. 14B is a diagram showing an example of the current frame f1 of image. FIG. 14C is a diagram with the frames f0 and f1 of image superimposed on top of each other. Arrows in FIG. 14C represent motion vectors. Matching between streetlights, pedestrians, white lines on the road, a vehicle ahead, and a vehicle on an intersecting road in the frame f0 of image and corresponding points in the frame f1 of image gives motion vectors whose initial points are positioned in the frame f0 and whose terminal points are positioned in the frame f1.

The matching process may be performed by a method of template matching typified, for example, by sum of squared difference(SSD) or sum of absolute difference(SAD). In the present embodiment, a figure of an edge including a feature point serves as a template image, and a portion in an image differing less from this template image is extracted. Matching may involve the use of a method other than this.

### Step S1407

The relative velocity vector module 312 generates a motion vector based on own-vehicle movement. The motion vector based on own-vehicle movement represents a relative movement, i.e. apparent movement, of a stationary object as seen from the own vehicle. The relative velocity vector module 312 generates a motion vector based on own-vehicle movement at the initial point of each motion vector generated in step S1406. The motion vector based on own-vehicle movement is generated on the basis of the information acquired in step S1401 on the direction and distance of movement during the period from the timing of the immediately preceding frame f0 to the timing of the current frame f1 and information on the correspondence relationship between coordinates of vanishing point of motion vector based on own-vehicle movement, distance from vanishing point, and magnitude of vector stored in the storage device 350 as shown in FIG. 10. The motion vector based on own-vehicle movement is a vector pointing in a direction opposite to the direction of movement of the own vehicle. FIG. 14D is a diagram showing examples of motion vectors based on own-vehicle movement. A more detailed process in step S1407 will be described later.

### Step S1408

The relative velocity vector module 312 generates a relative velocity vector that is the difference between the motion vector of each feature point generated in step S1406 and an apparent motion vector based on own-vehicle movement generated in step S1407. The relative velocity vector module 312 stores, in the storage device 320, the coordinates of the initial and terminal points of the relative velocity vector thus generated. As shown in FIG. 8D, the relative velocity vector is stored in such a form as to correspond to each feature point in the current frame. FIG. 14E shows examples of relative velocity vectors. The relative velocity vectors are generated by subtracting the motion vectors based on own-vehicle movement shown in FIG. 14D from the motion vectors shown in FIG. 14C. For the streetlights and the white lines, which are standing still, and the pedestrians, who are standing almost still, the relative velocity vectors are substantially 0. On the other hand, for the vehicle ahead and the vehicle on the intersecting road, relative velocity vectors whose lengths are greater than 0 are obtained. In the example shown in FIG. 14E, a vector V1 generated by subtracting a motion vector based on own-vehicle movement from the motion vector of the vehicle ahead is a vector indicating a direction away from the own vehicle. Meanwhile, a vector V2 generated by subtracting an apparent motion vector based on own-vehicle movement from the motion vector of the vehicle on the intersecting road is a vector indicating a direction toward the own vehicle. After step S1408, the operation returns to step S1402.

By repeating the operation from step S1402 to step S1408, the processing apparatus 300 generates relative velocity vectors for all feature points in the frames.

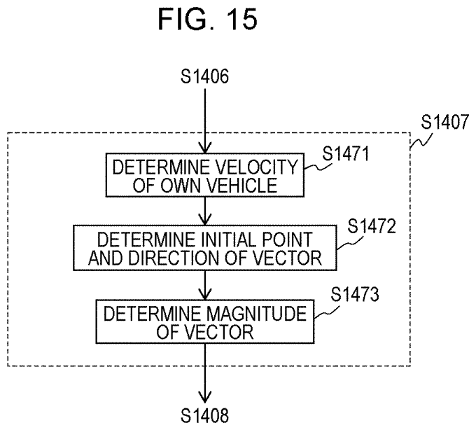

FIG. 15 is a flow chart showing details of a process for calculating a motion vector based on own-vehicle movement in step S1407. Step S1407 includes steps S1471 to S1473 shown in FIG. 15. The following describes the action of each of these steps.

### Step S1471

The relative velocity vector module 312 of the processing apparatus 300 determines the velocity of the own vehicle from the distance of movement during the period from the timing of the immediately preceding frame f0 and the timing of the current frame f1 that was acquired in step S1401 and a time interval between the frames.

### Step S1472

The relative velocity vector module 312 refers to the storage device 350 and acquires the coordinates of a vanishing point in an image. The relative velocity vector module 312 regards the initial point of each motion vector generated in step S1406 as the initial point of an apparent motion vector based on own-vehicle movement. In a case where the movable body mounted with the distance measurement system 10 travels substantially in the direction of the vanishing point, the direction from the vanishing point toward the initial point of the motion vector is regarded as the direction of the apparent motion vector based on own-vehicle movement.

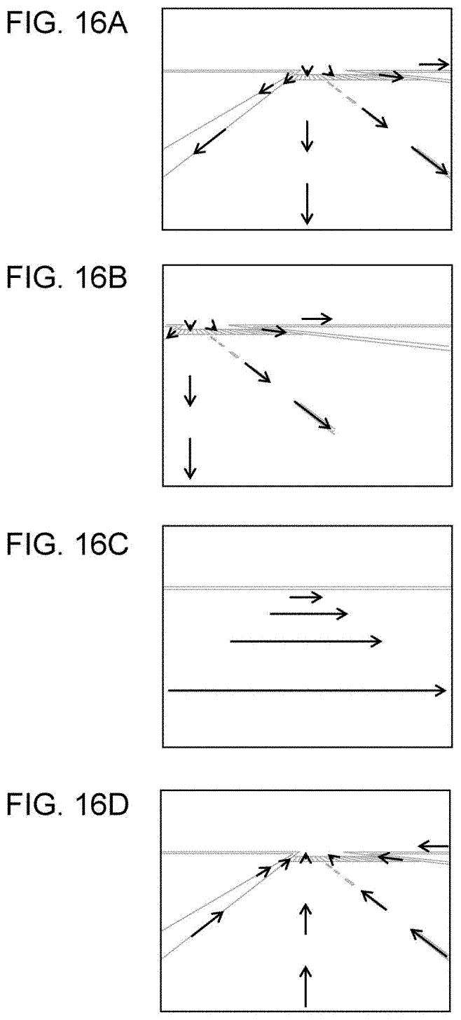

FIGS. 16A to 16D are diagrams each showing examples of the coordinates of a vanishing point and apparent motion vectors based on own-vehicle movement. FIG. 16A shows examples of apparent motion vectors in a case where the distance measurement system 10 is placed at the front of the movable body and the movable body is traveling forward. FIG. 16B shows examples of apparent motion vectors in a case where the distance measurement system 10 is placed at the right front of the movable body and the movable body is traveling forward. For the examples shown in FIGS. 16A and 16B, the directions of the apparent motion vectors based on own-vehicle movement are determined by the aforementioned method. FIG. 16C shows examples of apparent motion vectors in a case where the distance measurement system 10 is placed on the right side of the movable body and the movable body is traveling forward. In the example shown in FIG. 16C, the path of the movable body mounted with the distance measurement system 10 is not within the viewing angle of imaging or distance measurement by the distance measurement system 10 but orthogonal to the line of sight of the distance measurement system 10. In such a case, the line of sight of the distance measurement system 10 is translated along the direction of movement of the movable body. For this reason, a direction opposite to the direction of movement of the movable body is the direction of a motion vector regardless of a vanishing point in the field of view of the distance measurement system 10. FIG. 16D shows examples of apparent motion vectors in a case where the distance measurement system 10 is placed at the center rear of the movable body and the movable body is traveling forward. In the example shown in FIG. 16D, the direction of travel of the movable body is expressed by a vector pointing in a direction opposite to that in which an example shown in FIG. 16A points, and the direction of an apparent motion vector is opposite to that of an example shown in FIG. 16A.

### Step S1473

The relative velocity vector module 312 refers to the storage device 350 and sets the magnitude of the vector according to the distance from the vanishing point to the initial point of the motion vector. Then, the relative velocity vector module 312 adds a correction according to the velocity of the movable body calculated in step S1471 and determines the magnitude of the vector. Through the foregoing process, a motion vector based on own-vehicle movement is determined.

### 1-2-2. Risk Calculation

Next, an operation that is performed by the risk calculation module 340 of the processing apparatus 300 is described in detail.

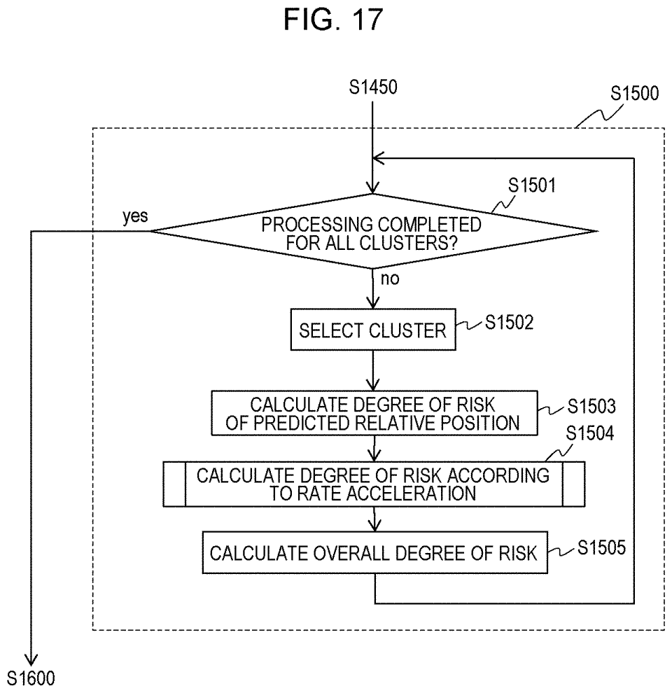

FIG. 17 is a flow chart showing details of a process of risk calculation in step S1500. Step S1500 includes steps S1501 to S1505 shown in FIG. 17. The following describes the action of each step.

### Step S1501

The risk calculation module 340 refers to the storage device 320 and determines whether the calculation of a degree of risk has been completed for all clusters generated and associated with the current frame f1 in step S1450. In a case where the calculation of a degree of risk has been completed for all clusters, the process proceeds to step S1600. In a case where the calculation of a degree of risk has not been completed for all clusters, the process proceeds to step S1502.

### Step S1502

The risk calculation module 340 selects, from among the clusters associated with the current frame f1, a cluster for which the calculation of a degree of risk has not been completed. The risk calculation module 340 refers to the storage device 320 and selects, from among the relative velocity vectors associated with the feature points included in the cluster thus selected and as the relative velocity vector of the cluster, a vector having a terminal point whose coordinates are nearest to the own-vehicle position.

### Step S1503

The risk calculation module 340 resolves the vector selected in step S1502 into the following two components. One of the two components is an own-vehicle direction vector component, i.e. a vector component pointing toward the position of the own vehicle or the imaging apparatus 100. For example, in an image of a scene generated by the imaging apparatus 100, this vector component is a component pointing toward the middle of the lower side of the image. The other of the two components is a vector component orthogonal to a direction toward the own vehicle. The terminal point of a vector twice as great in magnitude as the own-vehicle direction vector component is calculated as a relative position that the feature point in the frame f2 following the current frame f1 may assume with respect to the own vehicle. Furthermore, the risk calculation module 340 determines, with reference to the storage device 330, a degree of risk corresponding to the relative position, obtained from the relative velocity vector, that the feature point may assume with respect to the own vehicle.

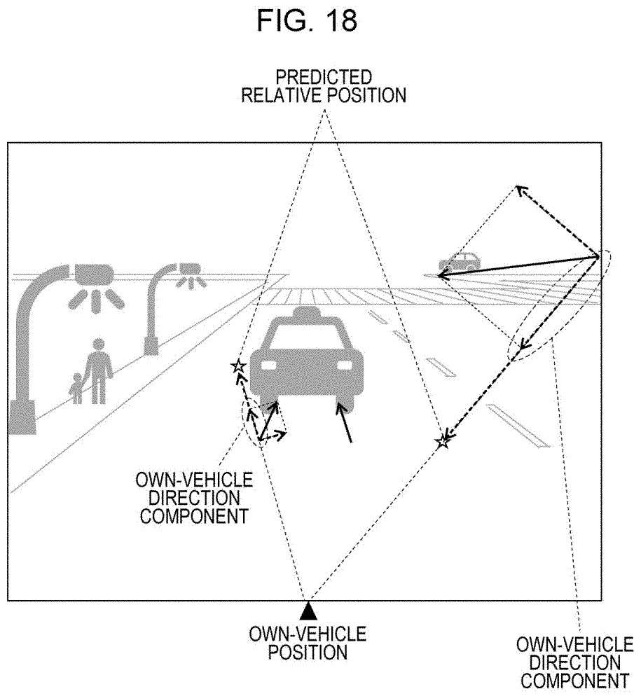

FIG. 18 is a diagram for explaining an example of a process of step S1503. The relative positions of feature points with respect to the own vehicle at the timing of the next frame f2 are indicated by stars, and the positions are obtained by applying the process of step S1503 to the relative velocity vectors shown in FIG. 14E. As in the case of this example, the position of a feature point of each cluster, i.e. physical object, in the next frame f2 is estimated, and a degree of risk according to the position is determined.

### Step S1504

The risk calculation module 340 calculates, on the basis of the movement plan information acquired in step S1401, calculates a degree of risk according to rate of acceleration. The risk calculation module 340 refers to the storage device 320 and generates an acceleration vector from the difference between a relative velocity vector from the immediately preceding frame f0 to the current frame f1 and a relative velocity vector from the current frame f1 to the next frame f2. The risk calculation module 340 determines a degree of risk according to acceleration vector with reference to the correspondence table of acceleration vector and degree of risk stored in the storage device 330.

### Step S1505

The risk calculation module 340 integrates the degree of risk according to predicted position calculated in step S1503 and the degree of risk according to rate of acceleration calculated in step S1504. The risk calculation module 340 calculates an overall degree of risk by multiplying the degree of risk according to predicted position by the degree of risk according to rate of acceleration. After step S1505, the process returns to step S1501.

By repeating the operation from step S1501 to step S1505, an overall degree of risk is calculated for all clusters.

Next, a more detailed example of a method for calculating a degree of risk according to rate of acceleration in step S1504 is described.

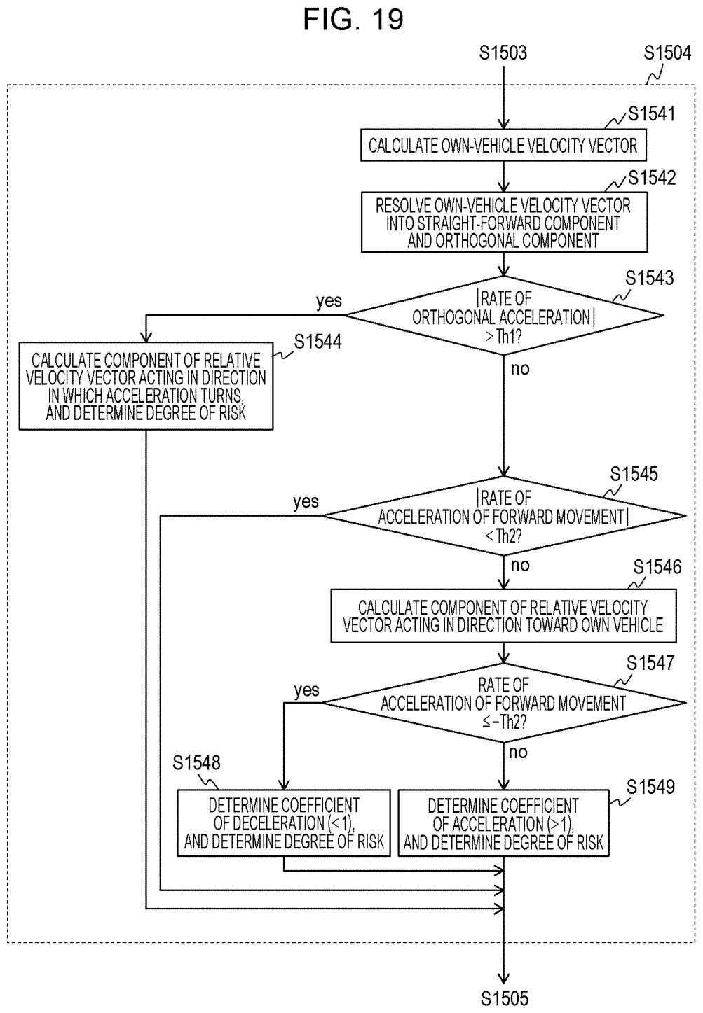

FIG. 19 is a flow chart showing a detailed example of a method for calculating a degree of risk according to rate of acceleration in step S1504. Step S1504 includes steps S1541 to S1549 shown in FIG. 19. The following describes the action of each step. It should be noted that the following description assumes that the imaging apparatus 100 and the distance measurement apparatus 200 are placed at the front of the vehicle. Examples of processes in cases where the imaging apparatus 100 and the distance measurement apparatus 200 are placed at other sites of the vehicle will be described later.

### Step S1541

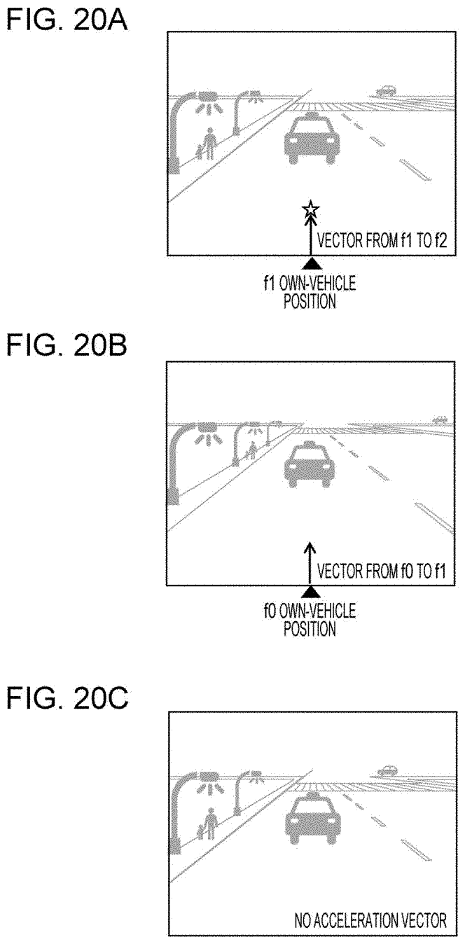

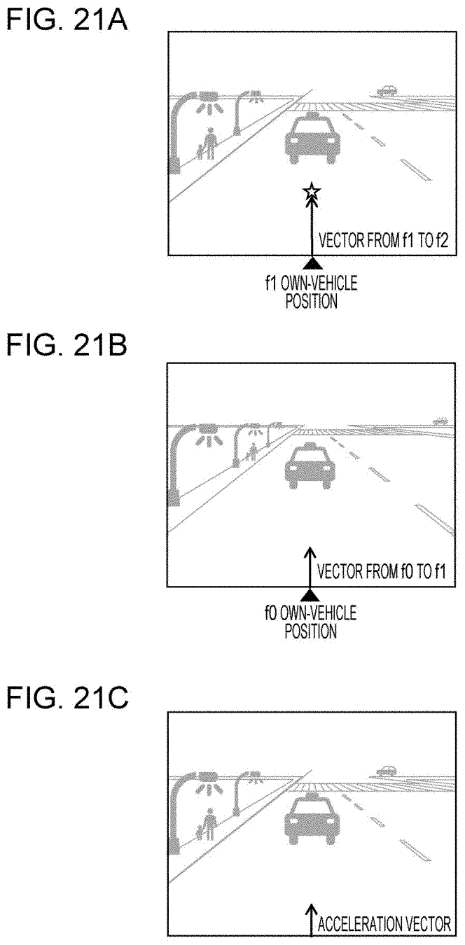

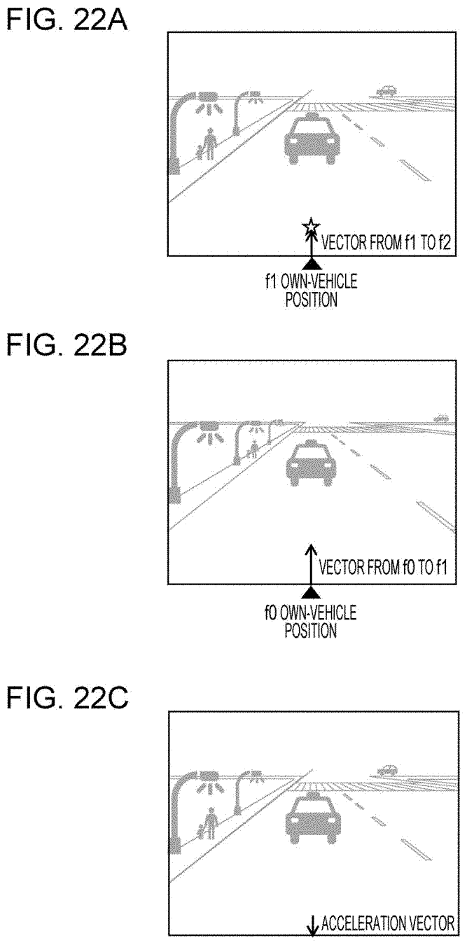

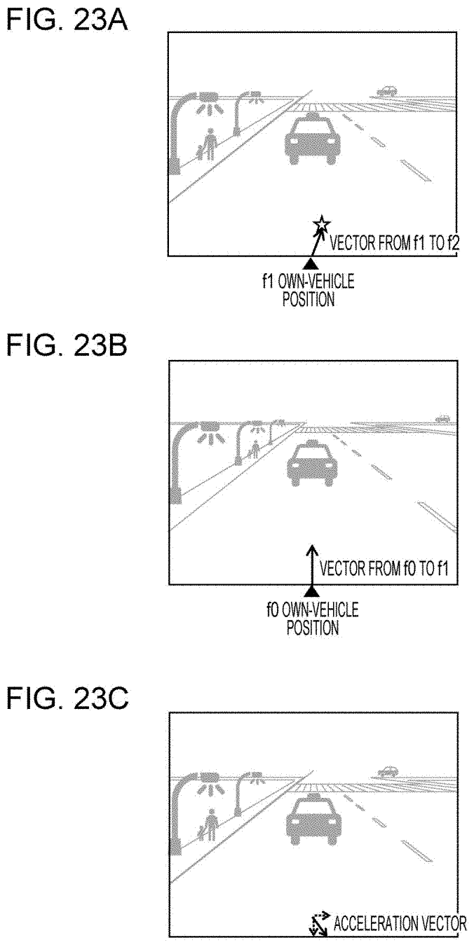

The risk calculation module 340 calculates the acceleration vector of the own vehicle on the basis of the movement plan information acquired in step S1401. FIGS. 20A to 20C are diagrams showing an example of a process for calculating an acceleration vector in a case where the own vehicle is traveling straight forward at a constant speed. FIGS. 21A to 21C are diagrams showing an example of a process for calculating an acceleration vector in a case where the own vehicle is traveling straight forward while accelerating. FIGS. 22A to 22C are diagrams showing an example of a process for calculating an acceleration vector in a case where the own vehicle is traveling straight forward while decelerating. FIGS. 23A to 23C are diagrams showing an example of a process for calculating an acceleration vector in a case where the own vehicle turns right. The movement plan information indicates, for example, the movement of the own vehicle during a period from the current frame f1 to the next frame f2. A vector corresponding to this movement is a vector whose initial point is at the position of the own vehicle in the current frame f1 and whose terminal point is at the predicted position of the own vehicle in the next frame f2. This vector is obtained by a process that is similar to that of step S1503. FIGS. 20A, 21A, 22A, and 23A show examples of vectors each indicating the movement of the own vehicle during the period from the current frame f1 to the next frame f2. Meanwhile, the movement of the own vehicle during the period from the immediately preceding frame f0 to the current frame f1 is expressed by a vector whose initial point is at the own-vehicle position and that points toward the coordinates of a vanishing point stored in the storage device 350. The magnitude of the vector depends on the distance between the position of the own vehicle and the coordinates of the vanishing point. FIGS. 20B, 21B, 22B, and 23B show examples of vectors each indicating the movement of the own vehicle during the period from the immediately preceding frame f0 to the current frame f1. The acceleration vector of the own vehicle is obtained by subtracting, from a vector representing the plan of movement of the own vehicle during the period from the current frame f1 to the next frame f2, a vector representing the movement of the own vehicle during the period from the immediately preceding frame f0 to the current frame f1. FIGS. 20C, 21C, 22C, and 23C show examples of acceleration vectors that are calculated. In the example shown in FIG. 20C, the acceleration vector is 0, as no rate of acceleration is generated.

### Step S1542

The risk calculation module 340 resolves the acceleration vector of the own vehicle obtained in step S1541 into a component acting in the direction of forward movement of the own vehicle and a component acting in an orthogonal direction. The component acting in the direction of forward movement is a component acting in a vertical direction in the drawings, and the component acting in an orthogonal direction is a component acting in a horizontal direction in the drawings. In each of the examples shown in FIGS. 20C, 21C, and 22C, the acceleration vector has only a component acting in the direction of forward movement. In the example shown in FIG. 23C, the acceleration vector has both a component acting in the direction of forward movement and a component acting in an orthogonal direction. It is in a case where the movable body changes direction that the acceleration vector has a component acting in an orthogonal direction.

### Step S1543

The risk calculation module 340 determines whether the absolute value of one of the components into which the acceleration vector was resolved in step S1542 that acts in an orthogonal direction exceeds a predetermined value Th1. In a case where the magnitude of the component acting in an orthogonal direction exceeds Th1, the process proceeds to step S1544. In a case where the magnitude of the component acting in an orthogonal direction does not exceed Th1, the process proceeds to step S1545.

### Step S1544

The risk calculation module 340 refers to the storage device 320 and calculates, for the relative velocity vector in the frame f1, the magnitude of a component acting in the same direction as the orthogonal component of the acceleration vector extracted in step S1542. The risk calculation module 340 refers to the storage device 330 and determines a degree of risk from the orthogonal component of the acceleration vector.

### Step S1545

The risk calculation module 340 determines whether the absolute value of one of the components into which the acceleration vector was resolved in step S1542 that acts in the direction of forward movement falls below a predetermined value Th2. In a case where the magnitude of the component acting in the direction of forward movement is less than Th2, the process proceeds to step S1505. In a case where the magnitude of the component acting in the direction of forward movement is greater than equal to Th2, the process proceeds to step S1546. A state where the magnitude of the component acting in the direction of forward movement is less than a certain value indicates that there is no rapid acceleration or deceleration. A state where the magnitude of the component acting in the direction of forward movement is greater than or equal to a certain value indicates that there is a certain degree of rapid acceleration or deceleration. In this example, a degree of risk according to rate of acceleration is not calculated in the case of poor acceleration or deceleration.

### Step S1546

The risk calculation module 340 refers to the storage device 320 and calculates, for the relative velocity vector in the current frame f1, the magnitude of a component acting in a direction toward the own vehicle.

### Step S1547

The risk calculation module 340 determines whether one of the components into which the acceleration vector was resolved in step S1542 that acts in the direction of forward movement is less than or equal to a predetermined value −Th2. In a case where the component acting in the direction of forward movement is less than or equal to −Th2, the process proceeds to step S1548. In a case where the component acting in the direction of forward movement is greater than −Th2, the process proceeds to step S1549. Note here that Th2 is a positive value. Accordingly, a state where the component of the acceleration vector acting in the direction of forward movement is less than or equal to −Th2 shows that there is a certain degree of rapid deceleration.

### Step S1548

The risk calculation module 340 refers to the storage device 320 and, for a relative velocity vector associated with the frame f1, multiplies the magnitude, calculated in step S1546, of a component acting toward the own vehicle by a coefficient of deceleration. The coefficient of deceleration is a value less than 1, and may be set as a value that is in inverse proportion to the absolute value of the rate of acceleration of forward movement calculated in step S1542. The risk calculation module 340 refers to the storage device 330 and determines a degree of risk from the straight-forward component of the acceleration vector.

### Step S1549

The risk calculation module 340 refers to the storage device 320 and, for a relative velocity vector associated with the frame f1, multiplies the magnitude, calculated in step S1546, of a component acting toward the own vehicle by a coefficient of acceleration. The coefficient of acceleration is a value greater than 1, and may be set as a value that is in proportion to the absolute value of the rate of acceleration of forward movement calculated in step S1542. The risk calculation module 340 refers to the storage device 330 and determines a degree of risk from the straight-forward component of the acceleration vector.

### 1-2-3. Determination of Distance Measurement Target on Basis of Degree of Risk

Next, a detailed example of an operation of step S1600 is described.

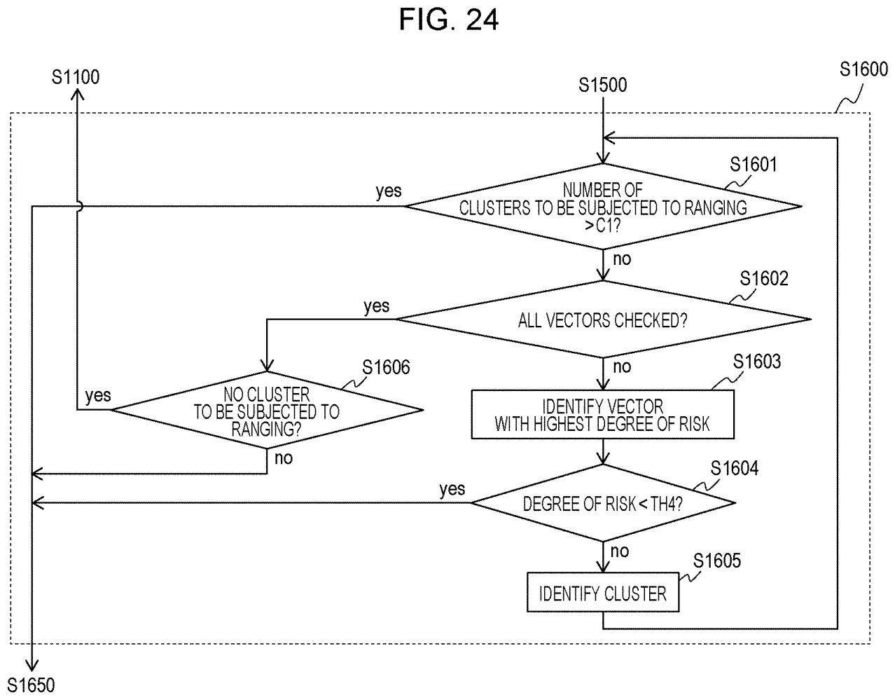

FIG. 24 is a flow chart showing a detailed example of the operation of step S1600. Step S1600 includes steps S1601 to S1606 shown in FIG. 24. The following describes the action of each step. The control circuit 230 of the distance measurement apparatus 200 determines a distance measurement target in accordance with a degree of risk for each cluster determined in step S1500 and determines the presence or absence of a distance measurement target.

### Step S1601

The control circuit 230 determines whether the number of clusters selected exceeds a predetermined value C1. In a case where the number of clusters selected as distance measurement targets exceeds C1, the operation proceeds to step S1650. In a case where the number of clusters selected as distance measurement targets is less than or equal to C1, the operation proceeds to step S1602.

### Step S1602

The control circuit 230 refers to the storage device 320 and determines whether a determination of a distance measurement target has been completed for all relative velocity vectors of the frame. In a case where a determination of a distance measurement target has been completed for all relative velocity vectors of the frame, the operation proceeds to step S1606. In a case where a determination of a distance measurement target has not been completed for all relative velocity vectors of the frame, the operation proceeds to step S1603.

### Step S1603

The control circuit 230 refers to the storage device 320 and extracts, from among the relative velocity vectors of the frame, vectors for which a determination of a distance measurement target has not been completed. In this example, a vector with the highest degree of risk is selected from among the vectors for which a determination of a distance measurement target has not been completed.

### Step S1604

The control circuit 230 determines whether the degree of risk of the relative velocity vector selected in step S1603 falls below a predetermined standard Th4. In a case where the degree of risk of the vector falls below Th4, the operation proceeds to step S1650. In a case where the degree of risk of the vector is greater than or equal to Th4, the operation proceeds to step S1605.

### Step S1605

The control circuit 230 determines, as a cluster to be subjected to distance measurement, a cluster including the vectors selected in step S1603 and determines that a determination of a distance measurement target has been completed for all vectors included in the cluster. After step S1605, the operation proceeds to step S1601.

### Step S1606

The control circuit 230 determines whether one or more clusters to be subjected to distance measurement have been extracted. In a case where no one cluster to be subjected to distance measurement has been extracted, the operation returns to step S1100. In a case where one or more clusters to be subjected to distance measurement have been extracted, the operation proceeds to step S1650.

By repeating steps S1601 to S1606, the control circuit 230 selects all clusters to be subjected to distance measurement. Although, in the present embodiment, the control circuit 230 executes the operation of step S1600, the processing apparatus 300 may execute the operation of step S1600 in place of the control circuit 230.

### 1-2-4. Distance Measurement

Next, a specific example of an operation of distance measurement in step S1700 is described.

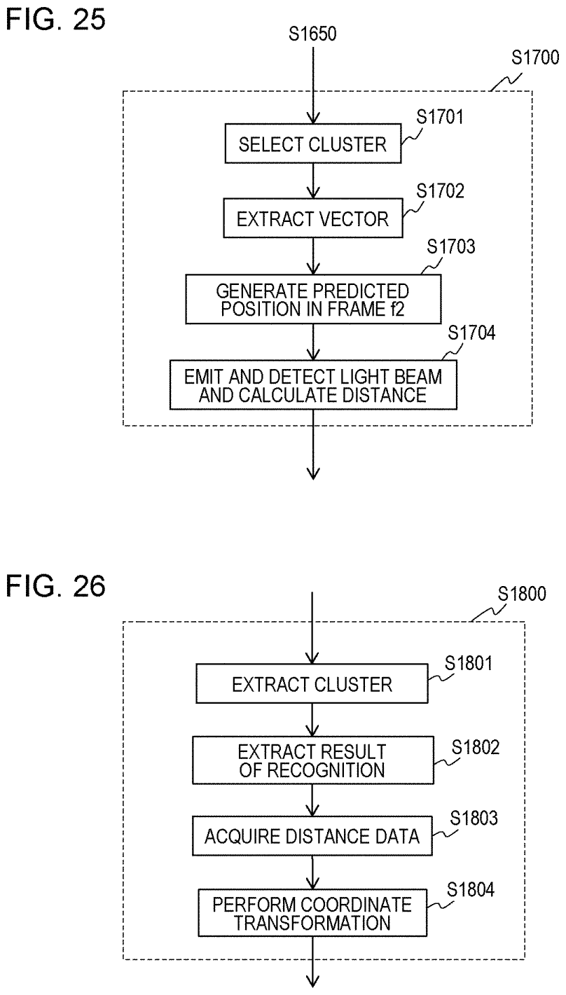

FIG. 25 is a flow chart showing a detailed example of the operation of distance measurement in step S1700. Step S1700 includes steps S1701 to S1703 shown in FIG. 25 The following describes the action of each step. For a cluster determined as a distance measurement target in step S1600, the control circuit 230 determines the direction of emission of the light beam on the basis of positional information in the next frame f2 that is predicted from relative velocity vectors within the cluster, and performs distance measurement.

### Step S1701

The control circuit 230 selects, from among the clusters selected in step S1600, a cluster yet to be subjected to distance measurement.

### Step S1702

The control circuit 230 refers to the storage device 320 and extracts a predetermined number of relative velocity vectors, e.g. not more than five relative velocity vectors, from among one or more relative velocity vectors corresponding to the cluster selected in step S1701. As a standard of extraction, for example, five relative velocity vectors that include a relative velocity vector with the highest degree of risk and whose terminal points are furthest away from one another may be selected.

### Step S1703

As shown in FIG. 18, as in the case of the risk calculation process of step S1503 shown in FIG. 17, for a relative velocity vector selected in step S1702, the control circuit 230 identifies, as the predicted position of the physical object, the position of the terminal point of a vector twice as great in magnitude as an own-vehicle direction component of the relative velocity vector. The control circuit 230 determines the direction of emission of the light beam so that the predicted position in the next frame f2 thus identified is illuminated with the light beam.

### Step S1704

The control circuit 230 outputs, to the light emitting device 210 and the light receiving device 220, controls signals that control, for example, the direction of emission of the light beam determined in step S1703, the timing of emission, the timing of exposure of the light receiving device 220, and the timing of data readout. Upon receiving the control signal, the light emitting device 210 emits the light beam. Upon receiving the control signal, the light receiving device 220 performs exposures and data output. Upon receiving a signal indicating a result of detection by the light receiving device 220, the processing circuit 240 calculates a distance to the physical object by the aforementioned method.

### 1-2-5. Data Integration and Output

Next, a specific example of a data integration process in step S1800 is described.

FIG. 26 is a flow chart showing a detailed example of the data integration process in step S1800. Step S1800 includes steps S1801 to S1804 shown in FIG. 26. The following describes the action of each step. The surrounding information generation module 370 of the processing apparatus 300 integrates data representing an area of a cluster indicating a physical object, a distance distribution within the cluster, and a result of recognition processing and outputs the data to the control apparatus 400.

### Step S1801

The surrounding information generation module 370 refers to the storage device 320 and extracts, from the data shown in FIG. 8D, a cluster subjected to distance measurement in step S1700.

### Step S1802

The surrounding information generation module 370 refers to the storage device 320 and extracts, from the data shown in FIG. 8D, a result of image recognition corresponding to the cluster extracted in step S1801.

### Step S1803

The surrounding information generation module 370 refers to the storage device 320 and extracts, from the data shown in FIG. 8D, a distance corresponding to the cluster extracted in step S1801. At this point in time, information on a distance, measured in step S1700, that corresponds to one or more relative velocity vectors within the cluster is extracted. In the case of a different distance for each relative velocity vector, the shortest distance may for example be adopted as the distance of the cluster. Alternatively, a representative value other than the minimum value, such the average or median of the plurality of distances, may be used as the distance of the cluster.

### Step S1804

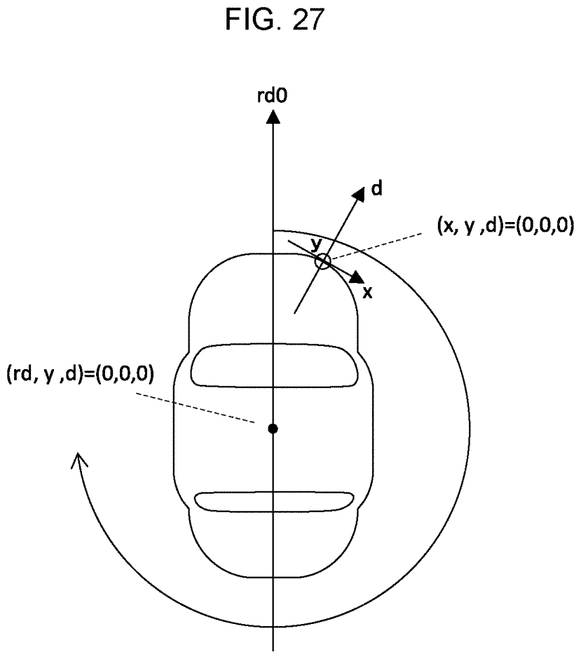

On the basis of information on the position and angle of view of the image sensor stored in advance in the storage device 350, the surrounding information generation module 370 converts, into data expressed in a coordinate system of the movable body mounted with the distance measurement system 10, coordinate data representing an area of the cluster extracted in step S1801 and the distance data determined in step S1803. FIG. 27 is a diagram showing an example of a coordinate system of the movable body. The coordinate system of the movable body in this example is a three-dimensional coordinate system that is expressed by a horizontal angle, a height, and a distance from the origin in a horizontal direction with the center of the movable body being the origin and the front of the movable body being at 0 degree. On the other hand, for example, as shown in FIG. 27 as a coordinate system having its origin at the right front of the movable body, a coordinate system of the distance measurement system 10 is a three-dimensional coordinate system constituted by an x-y coordinate and a distance. On the basis of the information on the position and angle of view of the sensor stored in the storage device 350, the surrounding information generation module 370 converts, into data expressed by the coordinate system of the movable body, data on a cluster range and a distance stored in the coordinate system of the distance measurement system 10.

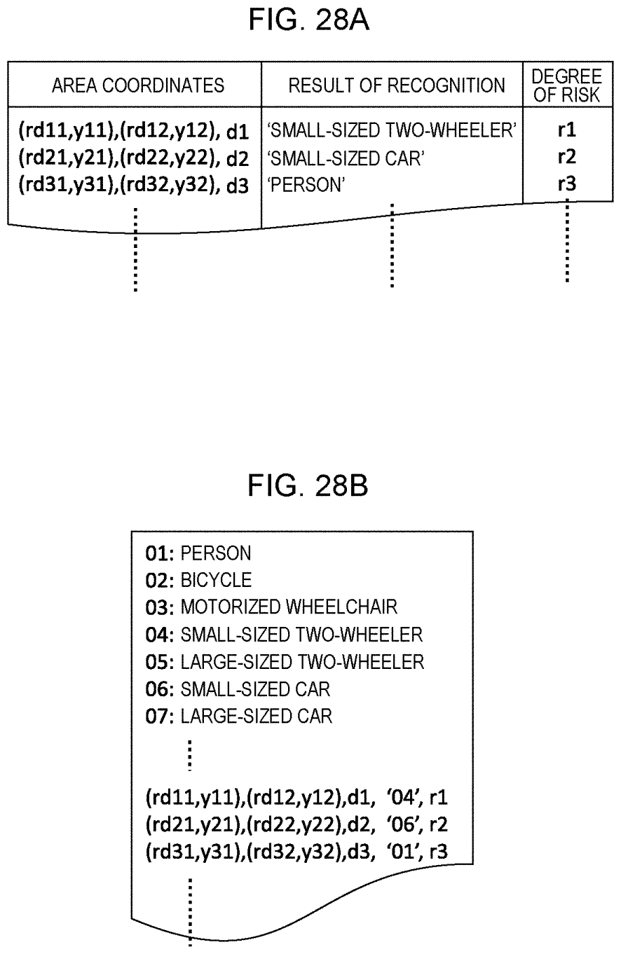

FIG. 28A is a diagram showing an example of output data that is generated by the processing apparatus 300. The output data in this example is data associating an area of each cluster with a distance, a result of recognition, and a degree of risk. The processing apparatus 300 generates such data and outputs it to the control apparatus 400 of the movable body. FIG. 28B is a diagram showing another example of output data. In this example, codes are assigned to contents of recognition, and the processing apparatus 300 adds a correspondence table of code and content of recognition to the beginning of the data and generates data in such a manner as to store only a code as a content of recognition in data for each cluster. Alternatively, in a case where a correspondence table of result of recognition and code is retained in advance in a storage device of the movable body, the processing apparatus 300 may output only a code serving as a result of recognition.

### 1-3. Effects

As noted above, a distance measurement system 10 of the present embodiment includes an imaging apparatus 100, a distance measurement apparatus 200, and a processing apparatus 300. The distance measurement apparatus 200 includes a light emitting device 210 capable of changing a direction of emission of a light beam along a horizontal direction and a vertical direction, a light receiving device 220 including an image sensor, a control circuit 230, and a processing circuit 240. The processing apparatus 300 generates a motion vector of one or more physical objects in a scene from a plurality of two-dimensional luminance images acquired by the imaging apparatus 100 taking a series of consecutive shots. The processing apparatus 300 calculates a degree of risk of the physical object on the basis of the motion vector and own-vehicle movement information acquired from the movable body including the distance measurement system 10. The control circuit 230 selects, on the basis of the degree of risk calculated by the processing apparatus 300, a physical object to be subjected to distance measurement. By emitting the light beam in a direction toward the physical object thus selected, the distance measurement apparatus 200 measures a distance to the physical object. The processing apparatus 300 outputs, to the control apparatus 400 of the movable body, data containing information on a range of coordinates of the physical object and a distance to the physical object.

The foregoing configuration makes it possible to select, in a scene to be subjected to distance measurement by the distance measurement system 10, a physical object having a high degree of risk such as collision and measure the distance to the physical object. This makes it possible, with a few distance measurement actions, acquire distance information that is effective in risk avoidance.

### 1-4. Modifications

Although, in Embodiment 1, the distance measurement system 10 includes an imaging apparatus 100 that acquires a luminance image, a distance measurement apparatus 200 that performs distance measurement, and a processing apparatus 300 that calculates a degree of risk, the present disclosure is not limited to such a configuration. For example, the processing apparatus 300 may be a constituent element of a movable body including the distance measurement system 10. In that case, the distance measurement system 10 includes an imaging apparatus 100 and a distance measurement apparatus 200. The imaging apparatus 100 acquires an image and outputs it to the processing apparatus 300 of the movable body. The processing apparatus 300 calculates, on the basis of the image acquired from the imaging apparatus 100, a degree of risk of one or more physical objects in the image, identifies a physical object to be subjected to distance measurement, and outputs, to the distance measurement apparatus 200, information indicating a predicted position of the physical object. The control circuit 230 of the distance measurement apparatus 200 controls the light emitting device 210 and the light receiving device 220 on the basis of the information on the predicted position of the physical object acquired from the processing apparatus 300. The control circuit 230 outputs, to the light emitting device 210, a control signal that controls the direction and timing of emission of a light beam, and outputs, to the light receiving device 220, a control signal that controls the timing of exposure. The light emitting device 210 emits the light beam in a direction toward the physical object in accordance with the control signal. The light receiving device 220 makes exposures for each separate pixel in accordance with the control signal and outputs, to the processing circuit 240, a signal indicating electric charge accumulated during each exposure period. The processing circuit 240 generates distance information on the physical object by calculating distances for each separate pixel on the basis of the signal.

The functions of the processing apparatus 300 and the control circuit 230 and processing circuit 240 of the distance measurement apparatus 200 may be integrated into a processing apparatus (e.g. the aforementioned control apparatus 400) of the movable body. In that case, the distance measurement system 10 includes an imaging apparatus 100, a light emitting device 210, and a light receiving device 220. The imaging apparatus 100 acquires an image and outputs it to the processing apparatus of the movable body. The processing apparatus of the movable body calculates, on the basis of the image acquired from the imaging apparatus 100, a degree of risk of one or more physical objects in the image, identifies a physical object to be subjected to distance measurement, and controls the light emitting device 210 and the light receiving device 220 so that the physical object is subjected to distance measurement. The processing apparatus outputs, to the light emitting device 210, a control signal that controls the direction and timing of emission of a light beam, and outputs, to the light receiving device 220, a control signal that controls the timing of exposure. The light emitting device 210 emits the light beam in a direction toward the physical object in accordance with the control signal. The light receiving device 220 makes exposures for each separate pixel in accordance with the control signal and outputs, to the processing apparatus of the movable body, a signal indicating electric charge accumulated during each exposure period. The processing apparatus generates distance information on the physical object by calculating distances for each separate pixel on the basis of the signal.

In Embodiment 1, the operation from step S1100 to S1900 shown in FIG. 11 is executed for each of frames that the imaging apparatus 100 consecutively generates. However, it is not necessary to execute all of the operation from step S1100 to S1900 in all frames. For example, a physical object determined as a distance measurement target in step S1600 may continue to be a distance measurement target in a subsequent frame without making, on the basis of an image acquired from the imaging apparatus 100, a determination as to whether the physical object is a distance measurement target. In other words, a physical object once determined as a distance measurement target may be stored as a target of tracking in a subsequent frame, and the process from step S1400 to step S1600 may be skipped. In this case, the end of tracking may be determined, for example, according to the following conditions:

Case where the physical object has gone out of the angle of view of the imaging apparatus 100, or
Case where a measured distance to the physical object has exceeded a predetermined value.

The tracking may be refreshed every two or more predetermined fames. Alternatively, in a case where the rate of acceleration of forward movement is greater than the threshold Th1 in step S1543 shown in FIG. 19, the tracking may be refreshed by calculating a degree of risk for a cluster to be tracked.

Embodiment 1 has been described with a focus on a case where the distance measurement system 10 is installed at the center front of the movable body. The following describes examples of the process of relative velocity vector calculation in step S1400 in a case where the distance measurement system 10 is installed at the right front of the movable body, a case where the distance measurement system 10 is installed on the right side of the movable body, and a case where the distance measurement system 10 is installed at the center rear of the movable body.

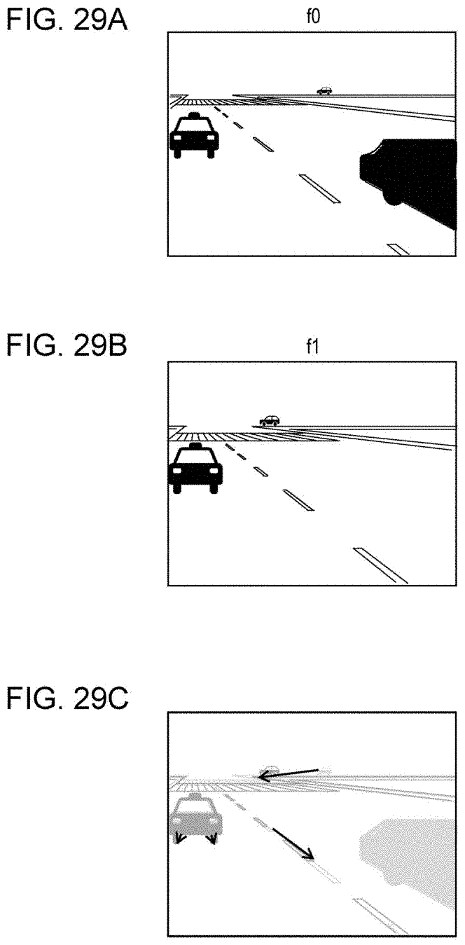

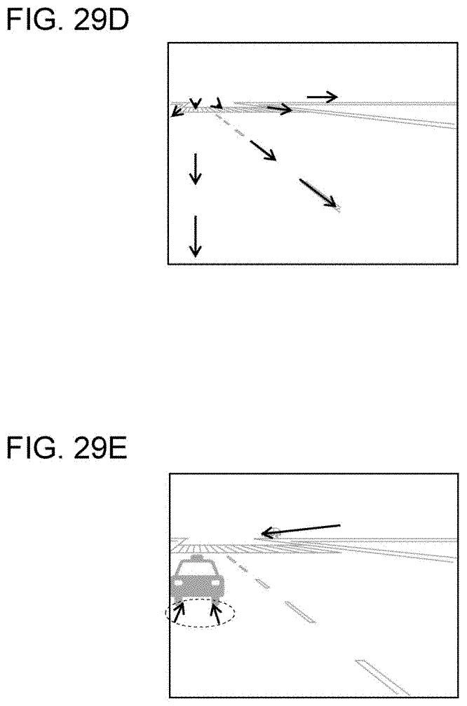

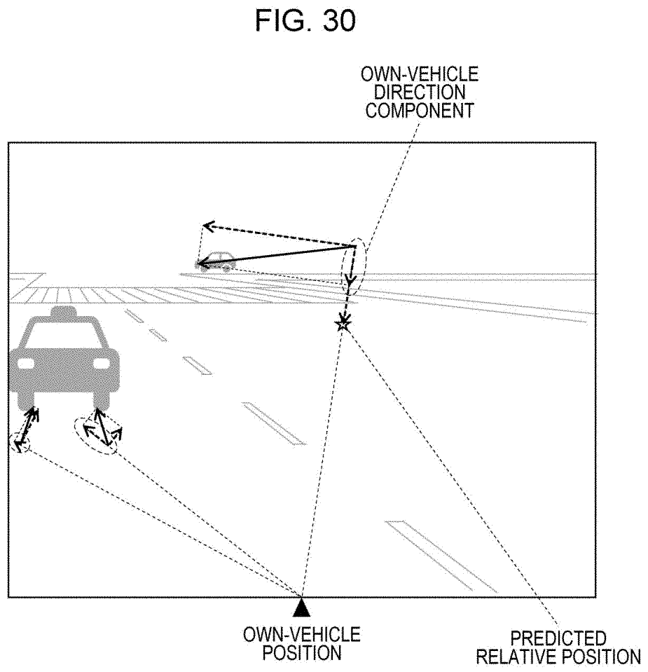

FIGS. 29A to 29E are diagrams each schematically showing an example of a scene on which the distance measurement system 10 performs imaging and distance measurement in a case where the distance measurement system 10 is installed at the right front of the movable body. FIG. 29A is a diagram showing an example of an immediately preceding frame f0 of image. FIG. 29B is a diagram showing an example of a current frame f1 of image. FIG. 29C is a diagram with the frames f0 and f1 of image superimposed on top of each other. Arrows in FIG. 29C represent motion vectors. FIG. 29D is a diagram showing examples of motion vectors based on own-vehicle movement. FIG. 29E is a diagram showing examples of relative velocity vectors. The processing apparatus 300 generates a relative velocity vector using a current frame f1 of two-dimensional image processed in step S1300 and an immediately preceding frame f0 of two-dimensional image processed in step S1300. The processing apparatus 300 performs matching between a feature point in the current frame f1 and a feature point in the immediately preceding frame f0. For the feature points thus matched, as illustrated in FIG. 29C, a motion vector connecting the position of the feature point in the frame f0 with the position of the feature point in the frame f1 is generated. The processing apparatus 300 calculates a relative velocity vector by subtracting, from the motion vector thus generated, a vector based on own-vehicle movement shown in FIG. 29D. As illustrated in FIG. 29E, the relative velocity vector is associated with the feature point in the frame f1 used for the calculation of the relative velocity vector, and is stored in the storage device 320 in such a form as to describe the coordinates of the initial and terminal points of the vector. FIG. 30 is a diagram showing an example of a predicted relative position of a physical object in a scene in a case where the distance measurement system 10 is installed at the right front of the movable body. As in the case of the example shown in FIG. 18, the processing apparatus 300 identifies the position of the terminal point of a vector twice as great in magnitude as an own-vehicle direction component of the relative velocity vector. The processing apparatus 300 identifies the position of the terminal point as a predicted relative position in the next frame f2 and determines the direction of emission so that the position is illuminated with the light beam.

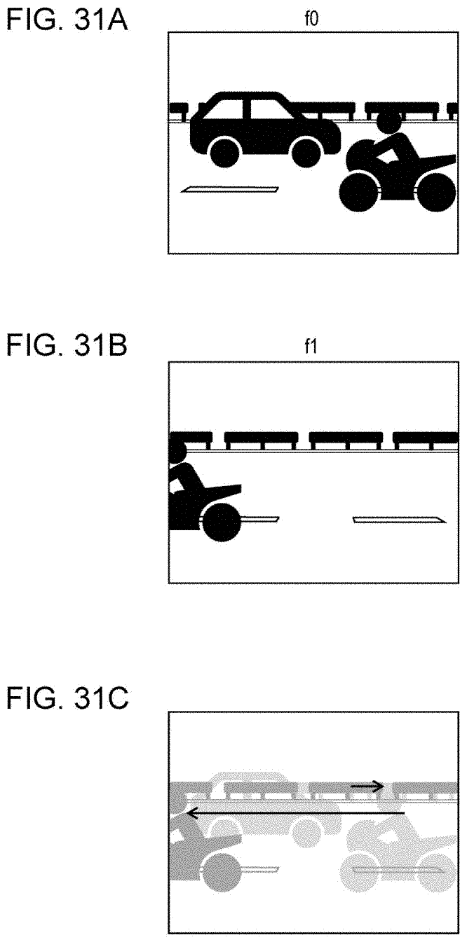

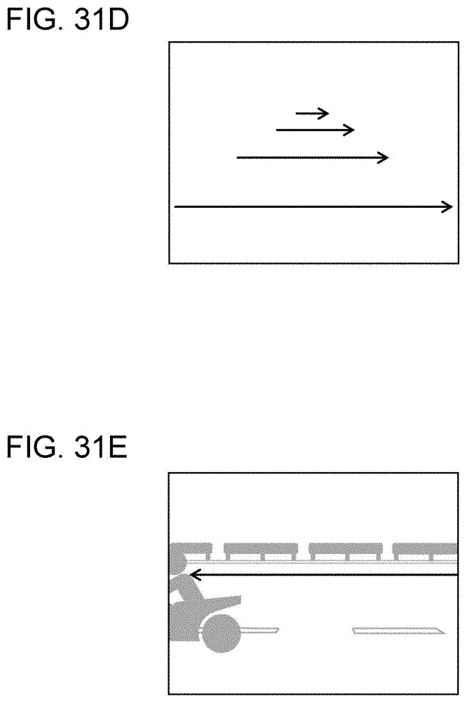

FIGS. 31A to 31E are diagrams each schematically showing an example of a scene on which the distance measurement system 10 performs imaging and distance measurement in a case where the distance measurement system 10 is installed on the right side of the movable body. FIG. 31A is a diagram showing an example of an immediately preceding frame f0 of image. FIG. 31B is a diagram showing an example of a current frame f1 of image. FIG. 31C is a diagram with the frames f0 and f1 of image superimposed on top of each other. Arrows in FIG. 31C represent motion vectors. FIG. 31D is a diagram showing examples of motion vectors based on own-vehicle movement. FIG. 31E is a diagram showing an example of a relative velocity vector. In this example too, the processing apparatus 300 generates a relative velocity vector using a current frame f1 of two-dimensional image and an immediately preceding frame f0 of two-dimensional image. The processing apparatus 300 performs matching between a feature point in the current frame f1 and a feature point in the immediately preceding frame f0. For the feature points thus matched, as illustrated in FIG. 31C, a motion vector connecting the position of the feature point in the frame f0 with the position of the feature point in the frame f1 is generated. The processing apparatus 300 calculates a relative velocity vector by subtracting, from the motion vector thus generated, a vector based on own-vehicle movement shown in FIG. 31D. In the example shown in FIG. 31E, when associated with the feature point in the frame f1, the relative velocity vector thus calculated becomes so great as to go beyond the right edge of the scene. For this reason, the predicted position in the next frame f2 based on the relative velocity vector is out of the angle of view of the distance measurement system 10. For this reason, the object corresponding to the feature point is not a target of illumination in the next frame f2. Further, the relative velocity vector shown in FIG. 31E is parallel to the vector based on own-vehicle movement and has no own-vehicle direction component. Therefore, the own-vehicle direction predicted relative position in the next frame f2 is the same as that in the current frame f1, so that there is no increase in degree of risk.

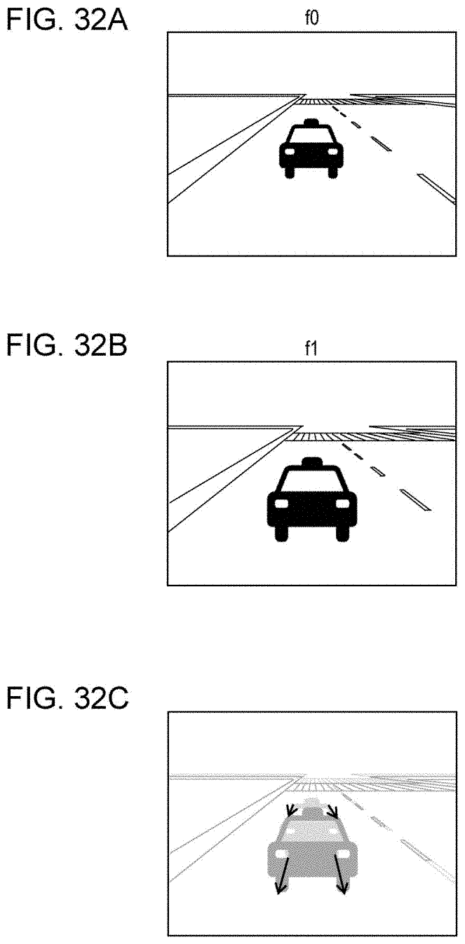

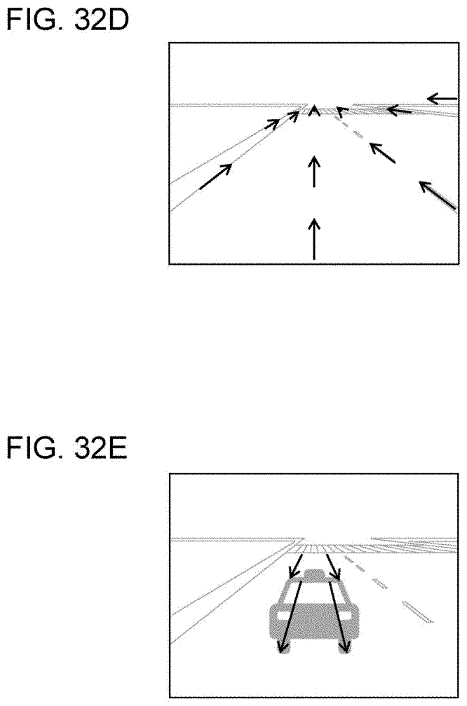

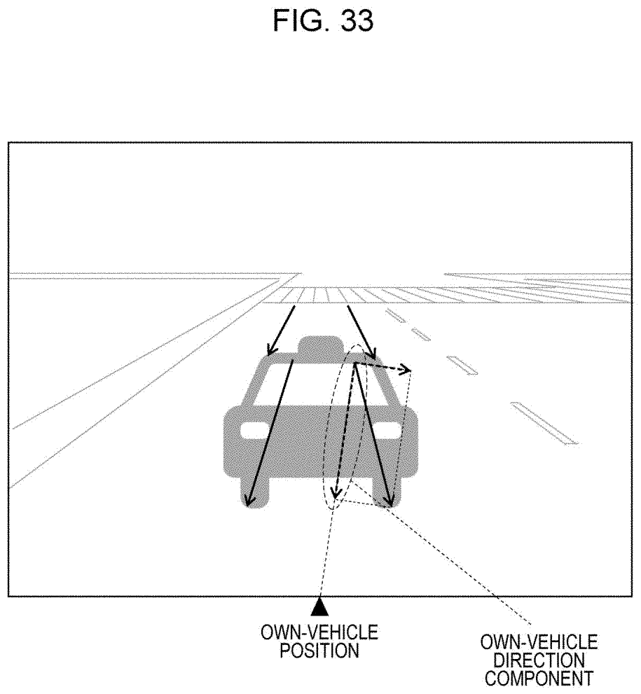

FIGS. 32A to 32E are diagrams each schematically showing an example of a scene on which the distance measurement system 10 performs imaging and distance measurement in a case where the distance measurement system 10 is installed at the center rear of the movable body. FIG. 32A is a diagram showing an example of an immediately preceding frame f0 of image. FIG. 32B is a diagram showing an example of a current frame f1 of image. FIG. 32C is a diagram with the frames f0 and f1 of image superimposed on top of each other. Arrows in FIG. 32C represent motion vectors. FIG. 32D is a diagram showing examples of motion vectors based on own-vehicle movement. FIG. 32E is a diagram showing examples of relative velocity vectors. In this example too, the processing apparatus 300 generates a relative velocity vector using a current frame f1 of two-dimensional image and an immediately preceding frame f0 of two-dimensional image. The processing apparatus 300 performs matching between a feature point in the current frame f1 and a feature point in the immediately preceding frame f0. For the feature points thus matched, as illustrated in FIG. 32C, a motion vector connecting the position of the feature point in the frame f0 with the position of the feature point in the frame f1 is generated. The processing apparatus 300 calculates a relative velocity vector by subtracting, from the motion vector thus generated, a vector based on own-vehicle movement shown in FIG. 32D. As illustrated in FIG. 32E, the relative velocity vector is associated with the feature point in the frame f1 used for the calculation of the relative velocity vector, and is stored in the storage device 320 in such a form as to describe the coordinates of the initial and terminal points of the vector. FIG. 33 is a diagram showing an example of a predicted relative position of a physical object in a scene in a case where the distance measurement system 10 is installed at the center rear of the movable body. As in the case of the example shown in FIG. 18, the processing apparatus 300 identifies the position of the terminal point of a vector twice as great in magnitude as an own-vehicle direction component of the relative velocity vector. The processing apparatus 300 identifies the position of the terminal point as a predicted relative position in the next frame f2 and determines the direction of emission so that the position is illuminated with the light beam.

The following describes examples of the process for calculating a degree of risk according to rate of acceleration in step S1504 shown in FIG. 17 in a case where the distance measurement system 10 is installed at the right front of the movable body, a case where the distance measurement system 10 is installed on the right side of the movable body, and a case where the distance measurement system 10 is installed at the center rear of the movable body.

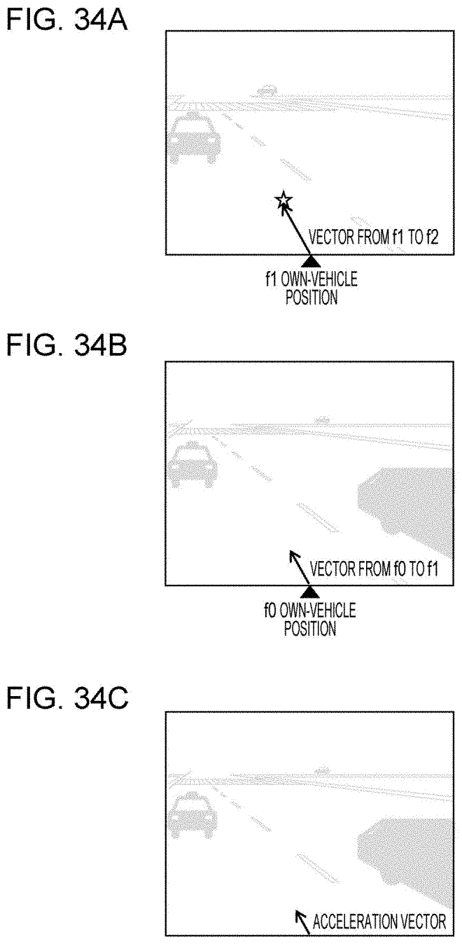

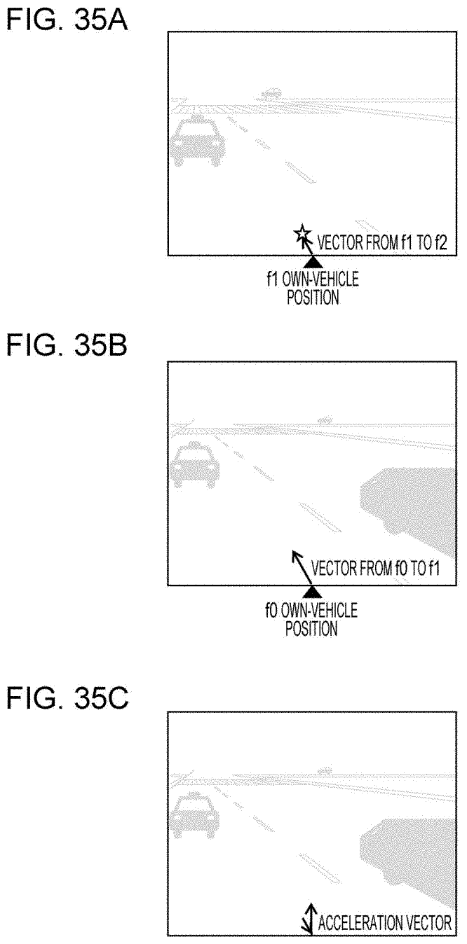

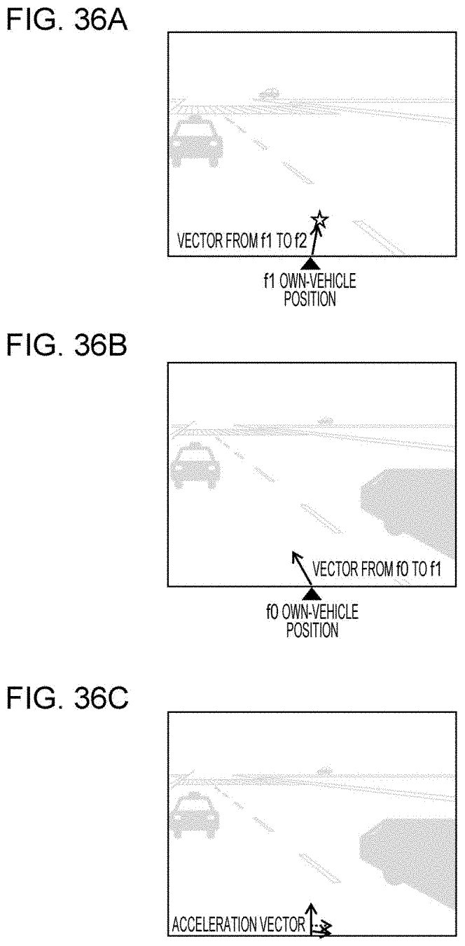

FIGS. 34A to 34C are diagrams each showing an example of a process for calculating an acceleration vector in a case where the distance measurement system 10 is installed at the right front of the movable body and the own vehicle is traveling straight forward while accelerating. FIGS. 35A to 35C are diagrams each showing an example of a process for calculating an acceleration vector in a case where the distance measurement system 10 is installed at the right front of the movable body and the own vehicle is traveling straight forward while decelerating. FIGS. 36A to 36C are diagrams each showing an example of a process for calculating an acceleration vector in a case where the distance measurement system 10 is installed at the right front of the movable body and the own vehicle turns right while decelerating.

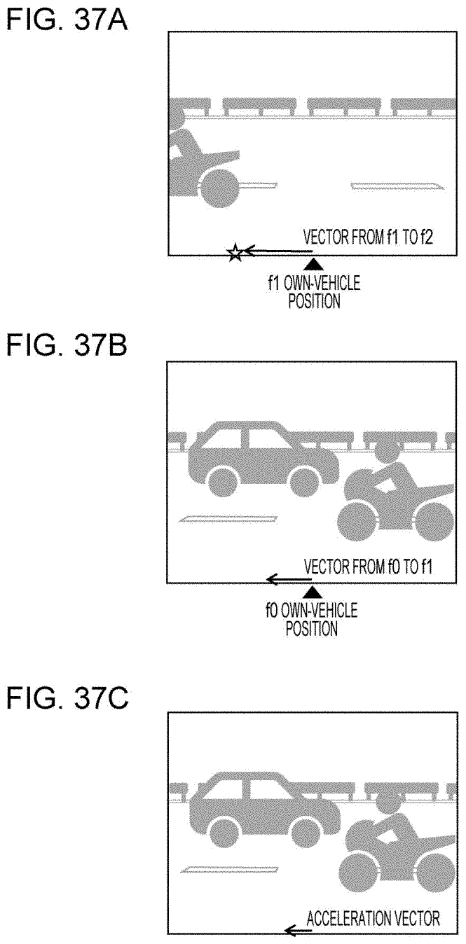

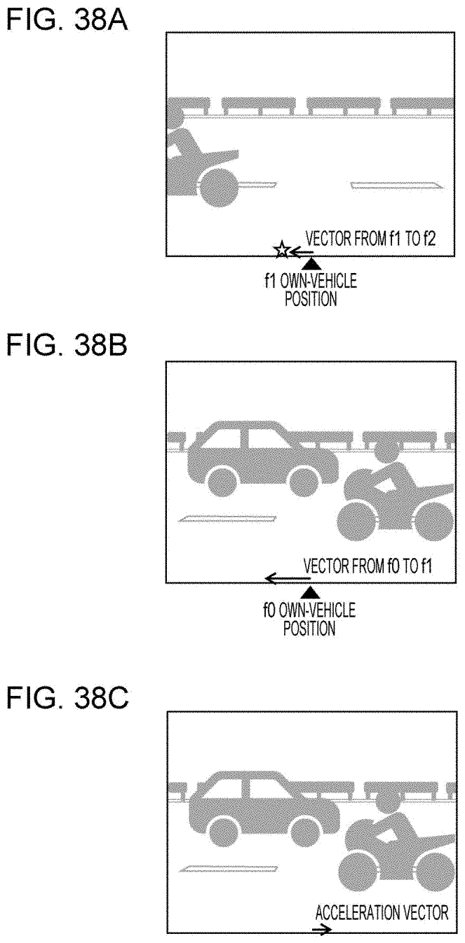

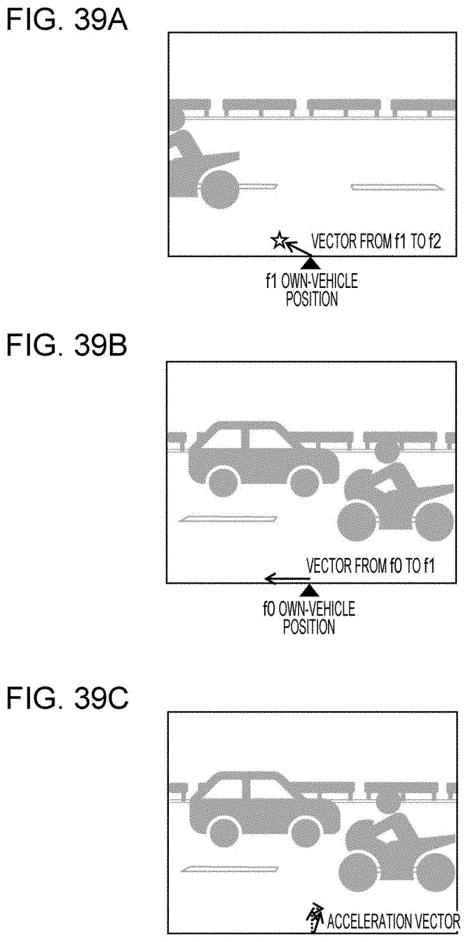

FIGS. 37A to 37C are diagrams each showing an example of a process for calculating an acceleration vector in a case where the distance measurement system 10 is installed on the right side of the movable body and the own vehicle is traveling straight forward while accelerating. FIGS. 38A to 38C are diagrams each showing an example of a process for calculating an acceleration vector in a case where the distance measurement system 10 is installed on the right side of the movable body and the own vehicle is traveling straight forward while decelerating. FIGS. 39A to 39C are diagrams each showing an example of a process for calculating an acceleration vector in a case where the distance measurement system 10 is installed on the right side of the movable body and the own vehicle turns right while decelerating.

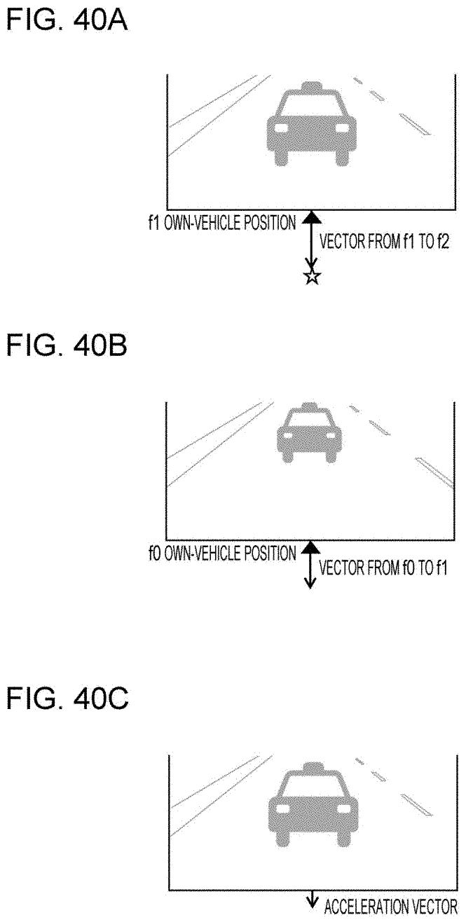

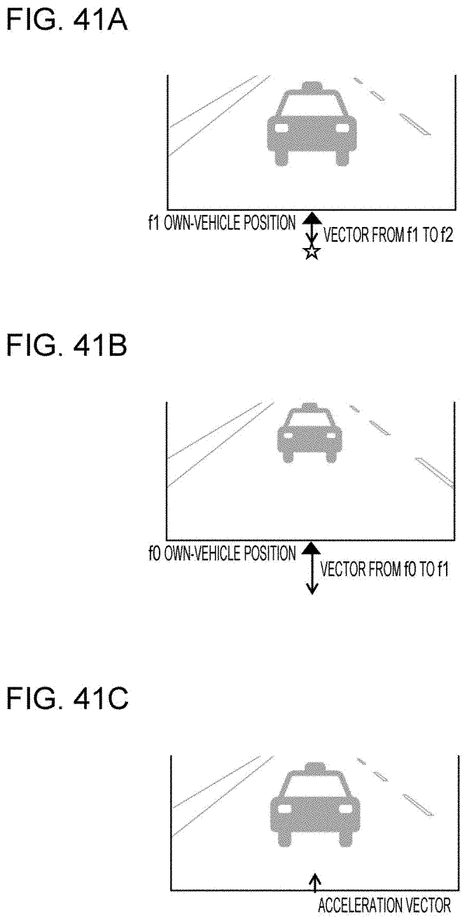

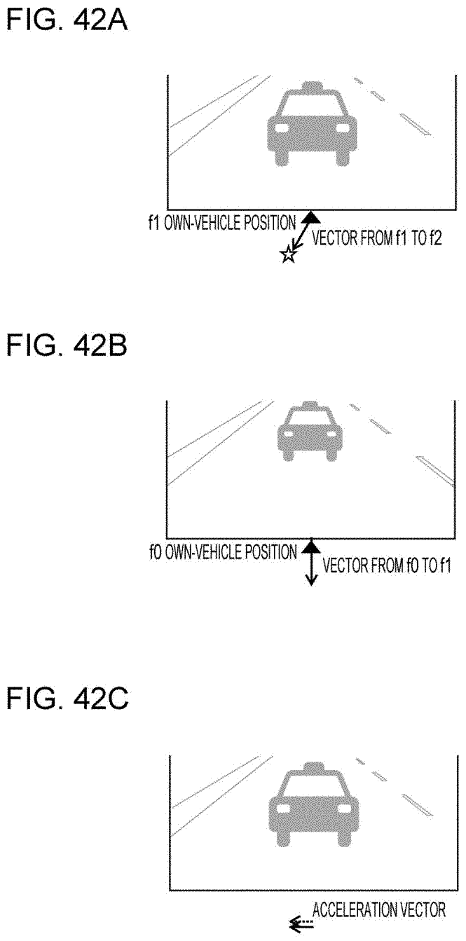

FIGS. 40A to 40C are diagrams each showing an example of a process for calculating an acceleration vector in a case where the distance measurement system 10 is installed at the center rear of the movable body and the own vehicle is traveling straight forward while accelerating. FIGS. 41A to 41C are diagrams each showing an example of a process for calculating an acceleration vector in a case where the distance measurement system 10 is installed at the center rear of the movable body and the own vehicle is traveling straight forward while decelerating. FIGS. 42A to 42C are diagrams each showing an example of a process for calculating an acceleration vector in a case where the distance measurement system 10 is installed at the center rear of the movable body and the own vehicle turns right while decelerating.

In each of these examples, the processing apparatus 300 calculates, on the basis of the movement plan information acquired in step S1401, a degree of risk according to rate of acceleration. The processing apparatus 300 refers to the storage device 320, obtains the difference between a vector representing the movement of the own vehicle during the period from the immediately preceding frame f0 to the current frame f1 and a vector representing the movement of the own vehicle during the period from the current frame f1 to the next frame f2, and generates an acceleration vector. FIGS. 34B, 35B, 36B, 37B, 38B, 39B, 40B, 41B, and 42B show examples of vectors each indicating the movement of the own vehicle during the period from the immediately preceding frame f0 to the current frame f1. FIGS. 34A, 35A, 36A, 37A, 38A, 39A, 40A, 41A, and 42A show examples of vectors each indicating the movement of the own vehicle during the period from the current frame f1 to the next frame f2. FIGS. 34C, 35C, 36C, 37C, 38C, 39C, 40C, 41C, and 42C show examples of acceleration vectors that are generated. The processing apparatus 300 determines a degree of risk according to acceleration vector with reference to the correspondence table of acceleration vector and degree of risk stored in the storage device 330. It should be noted that in a case where the distance measurement system 10 is situated at the rear of the movable body, the relationship between rate of acceleration of forward movement and degree of risk shown in FIG. 9B is inverted. In a case where the distance measurement system 10 is situated at the rear of the movable body, a correspondence table in which the sign of a rate of acceleration of forward movement in a case where the distance measurement system 10 is situated at the front of the movable body is inverted, or the processing apparatus 300 may obtain a degree of risk by inverting the sign of a rate of acceleration of forward movement.

In the foregoing embodiment, the processing apparatus 300 obtains a relative velocity vector and a relative position with respect to a physical object on the basis of a plurality of images acquired at different times by the imaging apparatus 100. Furthermore, the processing apparatus 300 obtains the rate of acceleration of the movable body on the basis of a plan of movement of the movable body including the distance measurement system 10 and determines the degree of risk of a physical object on the basis of the rate of acceleration. The distance measurement apparatus measures distances to physical objects in priority order of decreasing degree of risk. In order to measure a distance for each physical object, the distance measurement apparatus 200 configures the settings so that the light emitting device 210 emits the light beam in a direction toward each physical object.

In the foregoing operation, the distance measurement apparatus 200 may determine the numbers of occurrences of emission of the light beam and exposure during the distance measurement operation according to how high the degree of risk is. Alternatively, the distance measurement apparatus 200 may determine the time length of emission of the light beam and the time length of exposure during the distance measurement operation according to how high the degree of risk is. Such an operation makes it possible to adjust the accuracy of distance measurement or the distance range on the basis of the degree of risk.

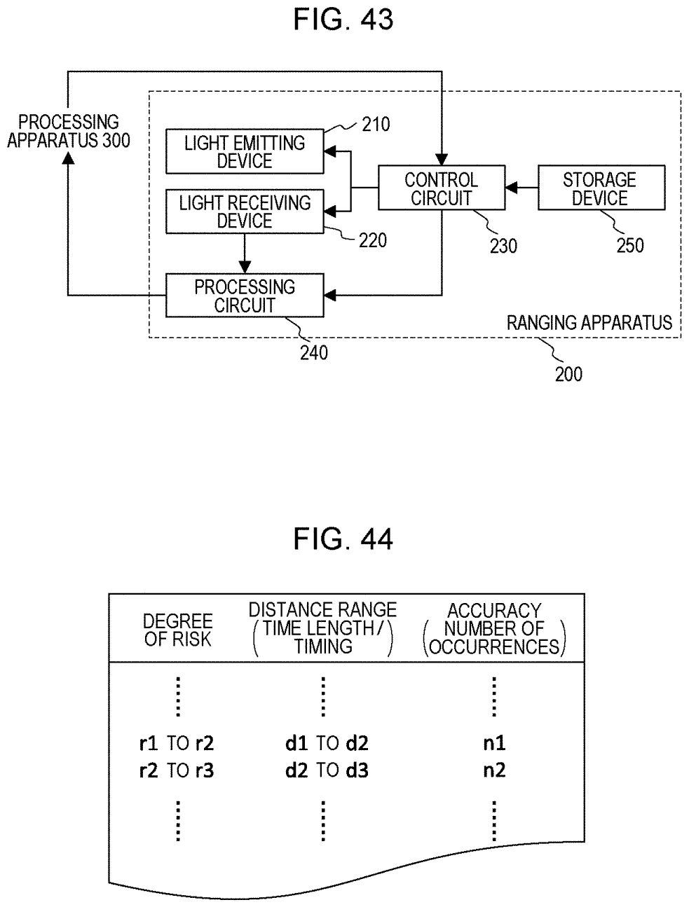

FIG. 43 is a block diagram showing an example configuration of the distance measurement apparatus 200 for achieving the foregoing operation. In this example, the distance measurement apparatus 200 includes a storage device 250 in addition to the constituent elements shown in FIG. 1. The storage device 250 has stored therein data defining a correspondence relationship between numbers of occurrences of emission of light beam and exposure and time lengths of emission of light beam and exposure according to degree of risk for each cluster, i.e. physical object, determined by the processing apparatus 300.

The control circuit 230 refers to the storage device 250 and determines, according to a degree of risk calculated by the processing apparatus 300, the time length of the light beam that the light emitting device 210 emits and the number of occurrences of emission. Furthermore, the control circuit 230 determines the time length of exposure of the light receiving device 220 and the number of occurrences of exposure according to the degree of risk. With this, the control circuit 230 controls the operation of distance measurement and adjusts the accuracy of distance measurement and the distance range.

FIG. 44 is a diagram showing an example of data that is stored by the storage device 250. In the example shown in FIG. 44, a correspondence table of range of degrees of risk, distance range, and accuracy is stored. Instead of the correspondence table, the storage device 250 may have stored therein a function for determining a distance range or accuracy from a degree of risk. Adjustment of the distance range can be achieved by adjusting the time length T0 of a light pulse and each exposure period in distance measurement based on an indirect TOF method illustrated, for example, in FIGS. 6 and 7. The longer T0 is made, the more the measurable distance range can be extended. Further, the measurable distance range can be shifted by adjusting the timing of the exposure period 1 shown in (c) of FIG. 6 and the timing of the exposure period 2 shown in (d) of FIG. 6. For example, the measurable distance range can be shifted toward a long-distance side by making the exposure period 1 later than the start of light emission instead of starting the exposure period 1 at the same time as the start of light emission. Note, however, that in this case, it is impossible to perform raging at such a short distance that the reflected light reaches the light receiving device 220 before the start of the exposure period 1. Even in a case where the start of the exposure period 1 is delayed, the time lengths of the exposure period 1 and the exposure period 2 are equal to the time length of light emission, and the exposure period 2 starts at the same time as the exposure period 1 ends. Further, the accuracy of distance measurement depends of the number or occurrences of distance measurement. Errors in distance measurement can reduced by a process of, for example, averaging results of more than one occurrence of distance measurement. By making the number of occurrences larger as the degree of risk becomes higher, the accuracy of distance measurement of a dangerous vehicle can be improved.

In the aforementioned embodiment, as shown in FIG. 8D, the storage device 320 has stored therein only the overall degree of risk obtained by integrating the degree of risk according to predicted relative position calculated in step S1503 and the degree of risk according to rate of acceleration calculated in step S1504. In this case, the storage device 250 has stored therein data defining correspondence among overall degree of risk, distance range, and accuracy. Meanwhile, the storage device 320 may have stored therein both the degree of risk according to predicted relative position and the degree of risk according to rate of acceleration. In that case, the storage device 250 may have stored therein a correspondence table or function for determining the distance range and accuracy of distance measurement from the degree of risk according to predicted relative position and the degree of risk according to rate of acceleration.

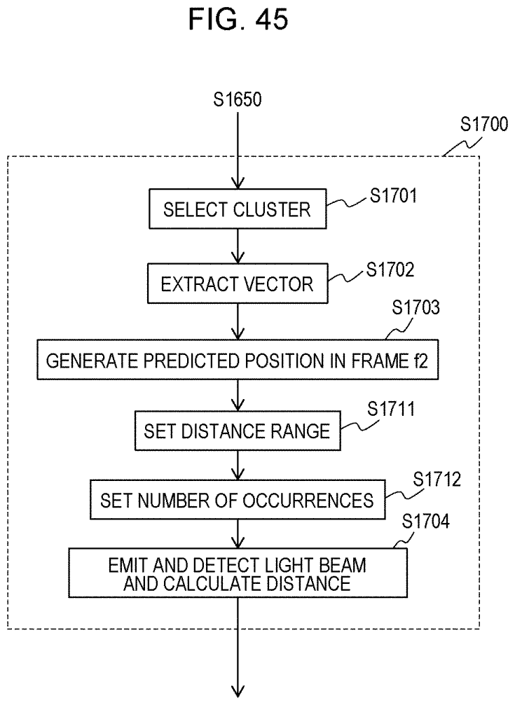

FIG. 45 is a flow chart showing an operation of distance measurement according to the modification that adjust the distance range of distance measurement and the number of occurrences according to the degree of risk. The flow chart shown in FIG. 45 has steps S1711 and S1712 added between steps S1703 and S1704 of the flow chart shown in FIG. 25. Further, emission and detection of the light beam is repeated the number of occurrences set. For the rest, the operation is the same as that of the aforementioned embodiment. The following describes points of differences from the operation of the aforementioned embodiment.

### Step S1711

The control circuit 320 refers to the storage device 320 and extracts a degree of risk corresponding to the cluster selected in step S1701. The control circuit 230 refers to the storage device 250 and determines a distance range corresponding to the degree of risk, i.e. the time length for which to emit the light beam and the time length of a period of exposure of the light receiving device 220. For example, the settings are configured so that the higher the degree of risk is, the shorter and longer distances the distance range includes. That is, the higher the degree of risk is, the longer the time length of emission of the light beam that is emitted from the light emitting device 210 and the time length of exposure of the light receiving device 220 become.

### Step S1712

The control circuit 230 refers to the storage device 250 and determines, on the basis of the degree of risk extracted in step S1711, the distance measurement accuracy corresponding to the degree of risk, i.e. the number of occurrences of an operation of emission and exposure. For example, the settings are configured such that the distance measurement accuracy is increased as the degree of risk becomes higher. That is, the number of occurrences of an operation of emission and light reception is increased as the degree of risk becomes higher.

### Step S1704

The control circuit 230 outputs, to the light emitting device 210 and the light receiving device 220, control signals that control the direction of emission of the beam determined in step S1703, the timing and time length of emission determined in step S1711, the timing and time length of exposure of the light receiving device 220 determined in step S1711, and the number of occurrences of a combined operation of emission and exposure determined in step S1712 and performs distance measurement. The method of distance measurement is as mentioned above.

According to the present modification, a physical object having a higher degree of risk can be subjected to distance measurement over a wider range and with a higher degree of accuracy. For distance measurement over a wide range and with a high degree of accuracy, a longer measurement time is required. For distance measurement of a plurality of physical objects within a certain period of time, for example, the duration of distance measurement of a physical object having a high degree of risk may be made relatively long, and the duration of distance measurement of a physical object having a low degree of risk may be made relatively short. Such an operation makes it possible to appropriately adjust the duration of a distance measurement operation as a whole.

The technologies disclosed here are widely applicable to distance measurement apparatuses or systems. For example, the technologies disclosed here may be used as constituent elements of a lidar (laser direction and distance measurement) system.

What is claimed is:

1. A method for controlling a distance measurement apparatus including a light emitting device configured to change a direction of emission of a light beam and a light receiving device that detects a reflected light beam produced by the emission of the light beam, the method comprising:
acquiring data representing a plurality of images acquired at different points in time by an image sensor that acquires an image of a scene;
determining, based on the data representing the plurality of images, a degree of priority of distance measurement of one or more physical objects included in the plurality of images; and
executing distance measurement of the one or more physical objects by causing the light emitting device to emit the light beam in a direction corresponding to the degree of priority and in an order corresponding to the degree of priority and causing the light receiving device to detect the reflected light beam.

2. The method according to claim 1, wherein
the distance measurement apparatus is mounted on a movable body,
the method includes acquiring, from the movable body, data representing a movement of the movable body, and
the degree of priority is determined based on the data representing the plurality of images and the data representing the movement of the movable body.

3. The method according to claim 2, wherein determining the degree of priority includes
generating a motion vector of the one or more physical objects based on the plurality of images,
generating, based on the data representing the movement of the movable body, a motion vector of a stationary object that is generated due to the movement of the movable body, and
determining the degree of priority based on a relative velocity vector that is a difference between the motion vector of the physical object and the motion vector of the stationary object.

4. The method according to claim 2, further comprising, after having executed the distance measurement, outputting, to the movable body, data containing information identifying the physical object and information indicating a distance to the physical object.

5. The method according to claim 4, wherein the degree of priority is determined based on a magnitude of a time change in the relative velocity vector.

6. The method according to claim 2, wherein
acquiring the data representing the plurality of images includes acquiring data representing first, second and third images consecutively acquired by the image sensor, and
determining the degree of priority includes
generating a first motion vector of the physical object based on the first image and the second image,
generating a second motion vector of the physical object based on the second image and the third image,
generating, based on the data representing the movement of the movable body, a motion vector of a stationary object that is generated due to the movement of the movable body,
generating a first relative velocity vector that is a difference between the first motion vector and the motion vector of the stationary object,
generating a second relative velocity vector that is a difference between the second motion vector and the motion vector of the stationary object, and
determining the degree of priority based on a difference between the first relative velocity vector and the second relative velocity vector.

7. The method according to claim 1, further comprising repeating more than once a cycle including acquiring the data representing the images, determining the degree of priority of distance measurement of the physical object, and executing the distance measurement of the physical object.

8. The method according to claim 7, wherein for a physical object on which the distance measurement was executed in a cycle, the distance measurement is continued in a next cycle without determining the degree of priority.

9. The method according to claim 1, further comprising determining a duration of illumination with the light beam according to the degree of priority.

10. The method according to claim 1, further comprising determining a number of occurrences of the emission of the light beam and detection of the reflected light beam according to the degree of priority.

11. The method according to claim 1, wherein the light receiving device include the image sensor.

12. The method according to claim 11, wherein the image sensor acquires the images from light emitted by the light emitting device.

13. The method according to claim 1, wherein
the distance measurement apparatus is mounted on board a movable body, and
determining the degree of priority includes
extracting a vector component of a relative velocity vector acting toward the movable body, the relative velocity vector being a difference between a motion vector of the physical object and a motion vector of a stationary object, and
determining the degree of priority based on a magnitude of the vector component acting toward the movable body.

14. The method according to claim 13, wherein the magnitude of the vector component acting toward the movable body assumes a value obtained by multiplying the vector component acting toward the movable body by a coefficient corresponding to a straight-forward component of an acceleration vector of the movable body.

15. The method according to claim 14, wherein the vector component acting toward the movable body is multiplied by the coefficient when a magnitude of the straight-forward component of the acceleration vector of the movable body is greater than or equal to a threshold.

16. The method according to claim 3, wherein determining the degree of priority includes
extracting an orthogonal component of an acceleration vector of the movement body acting orthogonally to a forward movement of the movable body, and
determining the degree of priority based on a magnitude of a vector component of the relative velocity vector of the physical object that is identical to the orthogonal component.

17. A control apparatus for controlling a distance measurement apparatus including a light emitting device capable of changing a direction of emission of a light beam and a light receiving device that detects a reflected light beam produced by the emission of the light beam, the control apparatus comprising:
a processor; and
a non-transitory computer-readable storage medium having stored thereon a computer program that is executed by the processor, the computer program causing the processor to execute operations including
acquiring data representing a plurality of images acquired at different points in time by an image sensor that acquires an image of a scene,
determining, based on the data representing the plurality of images, a degree of priority of distance measurement of one or more physical objects included in the plurality of images, and
executing distance measurement of the one or more physical objects by causing the light emitting device to emit the light beam in a direction corresponding to the degree of priority and in an order corresponding to the degree of priority and causing the light receiving device to detect the reflected light beam.

18. A system comprising:
the control apparatus according to claim 17; and
the light emitting device.

19. A non-transitory computer-readable storage medium having stored thereon a computer program that is executed by a processor that controls a distance measurement apparatus including a light emitting device capable of changing a direction of emission of a light beam and a light receiving device that detects a reflected light beam produced by the emission of the light beam, the computer program causing the processor to execute operations comprising:
acquiring data representing a plurality of images acquired at different points in time by an image sensor that acquires an image of a scene;
determining, based on the data representing the plurality of images, a degree of priority of distance measurement of one or more physical objects included in the plurality of images; and
executing distance measurement of the one or more physical objects by causing the light emitting device to emit the light beam in a direction corresponding to the degree of priority and in an order corresponding to the degree of priority and causing the light receiving device to detect the reflected light beam.
